(19) United States
(12) Patent Application Publication
(10) Pub. No.: US 2026/0238300 A1
(43) Pub. Date: Aug. 13, 2026

(54) ACCURACY AND CAPABILITIES FOR CROSS FREQUENCY-RANGE BEAM PREDICTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 19/153,576

(22) PCT Filed: Apr. 5, 2023
(86) PCT No.: PCT/CN2023/086344

§ 371 Date: Aug. 4, 2025

(51) Int. Cl. H04B 7/06; H04B 17/318

(52) U.S. Cl. CPC H04B 7/06952; H04B 17/318

(57) ABSTRACT

Methods, systems, and devices for wireless communications are described. A user equipment (UE) may monitor for one or more reference signals via a first set of one or more beams in a first radio frequency spectrum to obtain one or more measured signal characteristics. The UE may predict, based on the one or more measured signal characteristics associated with the first radio frequency spectrum, one or more predicted signal characteristics for a second set of one or more beams associated with a second radio frequency spectrum. The UE may transmit an indication of the one or more predicted signal characteristics based on an accuracy requirement that is associated with the first radio frequency spectrum, the second radio frequency spectrum, and one or more reference signal characteristics.

### CROSS REFERENCE

The present Application for Patent is a 371 national phase filing of International Patent Application No. PCT/CN2023/086344 by LI et al., entitled “ACCURACY AND CAPABILITIES FOR CROSS FREQUENCY-RANGE BEAM PREDICTION,” filed Apr. 5, 2023, assigned to the assignee hereof, and expressly incorporated by reference herein.

### TECHNICAL FIELD

The following relates to wireless communications, including accuracy and capabilities for cross frequency-range beam prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support accuracy and capabilities for cross frequency-range beam prediction. For example, the described techniques provide for a user equipment (UE) to measure signal characteristics of a first set of beams in a first radio frequency spectrum and predict signal characteristics for a second set of non-measured beams or resources in a second radio frequency spectrum. The UE may determine whether an accuracy of the signal characteristic predictions satisfies an accuracy requirement that is associated with cross-radio frequency spectrum prediction. For example, the accuracy requirement may be based on the first radio frequency spectrum as a measurement radio frequency spectrum and the second radio frequency spectrum as a prediction target radio frequency spectrum. In some examples, the accuracy requirement may be based on a reference signal characteristic, such as an ideal channel characteristic for the resource or a UE-measured channel characteristic for the resource. In some examples, different combinations of radio frequency spectrums may have different accuracy requirements. In some examples, the UE may report a capability associated with cross-radio frequency spectrum beam prediction. For example, the UE may report a capability on a quantity, type, or quality of measurement beams or predicted beams in order to achieve or satisfy an accuracy requirement. In some examples, the accuracy requirements may be based on the reported capability, preconfigured, or predefined, or any combination thereof. Additionally, or alternatively, a configuration for the measurement beams, predicted beams, or both, may be updated based on the reported capability.

A method for wireless communication at a UE is described. The method may include monitoring for one or more reference signals via a first set of one or more beams in a first radio frequency spectrum to obtain one or more measured signal characteristics, predicting, based on the one or more measured signal characteristics associated with the first radio frequency spectrum, one or more predicted signal characteristics for a second set of one or more beams associated with a second radio frequency spectrum, and transmitting an indication of the one or more predicted signal characteristics based on an accuracy requirement that is associated with the first radio frequency spectrum, the second radio frequency spectrum, and one or more reference signal characteristics.

An apparatus for wireless communication at a UE is described. The apparatus may include at least one processor and memory coupled (e.g., operatively, communicatively, functionally, electronically, or electrically) with the at least one processor. The memory may store instructions executable by the at least one processor to cause the UE to monitor for one or more reference signals via a first set of one or more beams in a first radio frequency spectrum to obtain one or more measured signal characteristics, predict, based on the one or more measured signal characteristics associated with the first radio frequency spectrum, one or more predicted signal characteristics for a second set of one or more beams associated with a second radio frequency spectrum, and transmit an indication of the one or more predicted signal characteristics based on an accuracy requirement that is associated with the first radio frequency spectrum, the second radio frequency spectrum, and one or more reference signal characteristics.

Another apparatus for wireless communication at a UE is described. The apparatus may include means for monitoring for one or more reference signals via a first set of one or more beams in a first radio frequency spectrum to obtain one or more measured signal characteristics, means for predicting, based on the one or more measured signal characteristics associated with the first radio frequency spectrum, one or more predicted signal characteristics for a second set of one or more beams associated with a second radio frequency spectrum, and means for transmitting an indication of the one or more predicted signal characteristics based on an accuracy requirement that is associated with the first radio frequency spectrum, the second radio frequency spectrum, and one or more reference signal characteristics.

A non-transitory computer-readable medium storing code for wireless communication at a UE is described. The code may include instructions executable by at least one processor (e.g., directly, indirectly, after pre-processing, without pre-processing) to monitor for one or more reference signals via a first set of one or more beams in a first radio frequency spectrum to obtain one or more measured signal characteristics, predict, based on the one or more measured signal characteristics associated with the first radio frequency spectrum, one or more predicted signal characteristics for a second set of one or more beams associated with a second radio frequency spectrum, and transmit an indication of the one or more predicted signal characteristics based on an accuracy requirement that is associated with the first radio frequency spectrum, the second radio frequency spectrum, and one or more reference signal characteristics.

Some examples of the method, apparatuses, and non-transitory computer-readable medium described herein may further include operations, features, means, or instructions for transmitting a control message indicating a capability of the UE to predict the one or more predicted signal characteristics associated with the first radio frequency spectrum and the second radio frequency spectrum.

In some examples of the method, apparatuses, and non-transitory computer-readable medium described herein, the control message indicates the capability of the UE to predict the one or more predicted signal characteristics based on beams of the second set of one or more beams having a narrower beam width than beams of the first set of one or more beams, the beams of the second set of one or more beams being more frequently transmitted than the beams of the first set of one or more beams, a time duration between predicting the one or more predicted signal characteristics and a time associated with the one or more predicted signal characteristics, or predicted signal characteristics being greater than measured signal characteristics, or any combination thereof.

In some examples of the method, apparatuses, and non-transitory computer-readable medium described herein, the control message indicates the capability of the UE to predict the one or more predicted signal characteristics based on a quantity of beams in the first set of one or more beams or the second set of one or more beams, a beam width of the beams in the first set of one or more beams or in the second set of one or more beams, a frequency of the beams in the first set of one or more beams or the second set of one or more beams, or any combination thereof.

In some examples of the method, apparatuses, and non-transitory computer-readable medium described herein, the control message indicates the capability of the UE to predict the one or more predicted signal characteristics based on a set of multiple pairs of radio frequency spectrums including at least a first pair of the first radio frequency spectrum and the second radio frequency spectrum.

Some examples of the method, apparatuses, and non-transitory computer-readable medium described herein may further include operations, features, means, or instructions for transmitting an indication of an updated capability of the UE to predict the one or more predicted signal characteristics.

In some examples of the method, apparatuses, and non-transitory computer-readable medium described herein, the updated capability of the UE may be based on a change to channel conditions, a change to resource availability at the UE, a change to the accuracy requirement, or any combination thereof.

Some examples of the method, apparatuses, and non-transitory computer-readable medium described herein may further include operations, features, means, or instructions for receiving a control message that configures the UE to predict the one or more predicted signal characteristics, where predicting the one or more predicted signal characteristics may be based on the control message.

In some examples of the method, apparatuses, and non-transitory computer-readable medium described herein, the control message identifies the first radio frequency spectrum and the second radio frequency spectrum for predicting the one or more predicted signal characteristics.

In some examples of the method, apparatuses, and non-transitory computer-readable medium described herein, receiving the control message may include operations, features, means, or instructions for receiving a system information message that configures the UE to predict the one or more predicted signal characteristics.

In some examples of the method, apparatuses, and non-transitory computer-readable medium described herein, the control message configures the UE to predict the one or more predicted signal characteristics based on a set of multiple pairs of radio frequency spectrums including at least a first pair of the first radio frequency spectrum and the second radio frequency spectrum.

In some examples of the method, apparatuses, and non-transitory computer-readable medium described herein, the control message indicates the accuracy requirement that may be associated with the first radio frequency spectrum and the second radio frequency spectrum.

Some examples of the method, apparatuses, and non-transitory computer-readable medium described herein may further include operations, features, means, or instructions for transmitting a request for an increased quantity of reference signals via the first set of one or more beams to predict the one or more predicted signal characteristics.

In some examples of the method, apparatuses, and non-transitory computer-readable medium described herein, the request for the increased quantity of reference signals identifies a channel state information (CSI) report setting associated with the first set of one or more beams.

In some examples of the method, apparatuses, and non-transitory computer-readable medium described herein, the one or more predicted signal characteristics satisfy the accuracy requirement based on the one or more predicted signal characteristics being within a threshold difference from the one or more measured signal characteristics and the one or more reference signal characteristics correspond to the one or more measured signal characteristics.

In some examples of the method, apparatuses, and non-transitory computer-readable medium described herein, the one or more predicted signal characteristics satisfy the accuracy requirement based on the one or more predicted signal characteristics being within a threshold difference from one or more ideal signal characteristics and the one or more reference signal characteristics correspond to the one or more ideal signal characteristics.

In some examples of the method, apparatuses, and non-transitory computer-readable medium described herein, the one or more predicted signal characteristics satisfy the accuracy requirement based on time-frequency resources associated with the one or more predicted signal characteristics corresponding to time-frequency resources associated with each of the one or more reference signal characteristics.

In some examples of the method, apparatuses, and non-transitory computer-readable medium described herein, the one or more predicted signal characteristics satisfy the accuracy requirement based on a time-frequency resource associated with highest predicted signal characteristic of the one or more predicted signal characteristics corresponding to a time-frequency resource associated with any of the one or more reference signal characteristics.

In some examples of the method, apparatuses, and non-transitory computer-readable medium described herein, the one or more predicted signal characteristics satisfy the accuracy requirement based on a time-frequency resource associated with a highest reference signal characteristic of the one or more reference signal characteristics corresponding to a time-frequency resource associated with any of the one or more predicted signal characteristics.

In some examples of the method, apparatuses, and non-transitory computer-readable medium described herein, the accuracy requirement may be a first accuracy requirement of a set of multiple accuracy requirements, each respective accuracy requirement of the set of multiple accuracy requirements being based on a first respective radio frequency spectrum associated with measurements and a second respective radio frequency spectrum associated with signal characteristic predictions.

In some examples of the method, apparatuses, and non-transitory computer-readable medium described herein, the accuracy requirement may be based on the one or more reference signal characteristics, a numerical quantity of the second set of one or more beams, a beam width associated with the second set of one or more beams, a beam type associated with the second set of one or more beams, a periodicity of the second set of one or more beams, or a combination thereof.

In some examples of the method, apparatuses, and non-transitory computer-readable medium described herein, the first radio frequency spectrum corresponds a first frequency range, and the second radio frequency spectrum corresponds to a second frequency range.

In some examples of the method, apparatuses, and non-transitory computer-readable medium described herein, the first radio frequency spectrum corresponds a first sub-portion of a first frequency range, and the second radio frequency spectrum corresponds to a second sub-portion of a second frequency range.

In some examples of the method, apparatuses, and non-transitory computer-readable medium described herein, the first radio frequency spectrum corresponds a first radio frequency spectrum band, and the second radio frequency spectrum corresponds to a second radio frequency spectrum band.

A method for wireless communication at a network entity is described. The method may include receiving a control message indicating a capability of a UE to predict one or more predicted signal characteristics of a second set of one or more beams in a second radio frequency spectrum based on one or more measured signal characteristics of a first set of one or more beams in a first radio frequency spectrum, transmitting one or more reference signals via the first set of one or more beams in the first radio frequency spectrum, and receiving an indication of the one or more predicted signal characteristics for the second set of one or more beams in the second radio frequency spectrum based on an accuracy requirement that is associated with the first radio frequency spectrum, the second radio frequency spectrum, and one or more reference signal characteristics.

An apparatus for wireless communication at a network entity is described. The apparatus may include a processor, memory coupled (e.g., operatively, communicatively, functionally, electronically, or electrically) with the at least one processor. The memory may store instructions executable by the at least one processor to cause the network entity to receive a control message indicating a capability of a UE to predict one or more predicted signal characteristics of a second set of one or more beams in a second radio frequency spectrum based on one or more measured signal characteristics of a first set of one or more beams in a first radio frequency spectrum, transmit one or more reference signals via the first set of one or more beams in the first radio frequency spectrum, and receive an indication of the one or more predicted signal characteristics for the second set of one or more beams in the second radio frequency spectrum based on an accuracy requirement that is associated with the first radio frequency spectrum, the second radio frequency spectrum, and one or more reference signal characteristics.

Another apparatus for wireless communication at a network entity is described. The apparatus may include means for receiving a control message indicating a capability of a UE to predict one or more predicted signal characteristics of a second set of one or more beams in a second radio frequency spectrum based on one or more measured signal characteristics of a first set of one or more beams in a first radio frequency spectrum, means for transmitting one or more reference signals via the first set of one or more beams in the first radio frequency spectrum, and means for receiving an indication of the one or more predicted signal characteristics for the second set of one or more beams in the second radio frequency spectrum based on an accuracy requirement that is associated with the first radio frequency spectrum, the second radio frequency spectrum, and one or more reference signal characteristics.

A non-transitory computer-readable medium storing code for wireless communication at a network entity is described. The code may include instructions executable by a processor at least one processor (e.g., directly, indirectly, after pre-processing, without pre-processing) to receive a control message indicating a capability of a UE to predict one or more predicted signal characteristics of a second set of one or more beams in a second radio frequency spectrum based on one or more measured signal characteristics of a first set of one or more beams in a first radio frequency spectrum, transmit one or more reference signals via the first set of one or more beams in the first radio frequency spectrum, and receive an indication of the one or more predicted signal characteristics for the second set of one or more beams in the second radio frequency spectrum based on an accuracy requirement that is associated with the first radio frequency spectrum, the second radio frequency spectrum, and one or more reference signal characteristics.

In some examples of the method, apparatuses, and non-transitory computer-readable medium described herein, the control message indicates the capability of the UE to predict the one or more predicted signal characteristics based on beams of the second set of one or more beams having a narrower beam width than beams of the first set of one or more beams, the beams of the second set of one or more beams being more frequently transmitted than the beams of the first set of one or more beams, a time duration between predicting the one or more predicted signal characteristics and a time associated with the one or more predicted signal characteristics, or predicted signal characteristics being greater than measured signal characteristics, or any combination thereof.

Some examples of the method, apparatuses, and non-transitory computer-readable medium described herein may further include operations, features, means, or instructions for transmitting control signaling that configures the UE to predict the one or more predicted signal characteristics, where receiving the indication of the one or more predicted signal characteristics may be based on the control message.

Some examples of the method, apparatuses, and non-transitory computer-readable medium described herein may further include operations, features, means, or instructions for receiving a request for an increased quantity of reference signals via the first set of one or more beams for the UE to predict the one or more predicted signal characteristics.

### BRIEF DESCRIPTION OF THE DRAWINGS

FIG. 1 shows an example of a wireless communications system that supports accuracy and capabilities for cross frequency-range beam prediction in accordance with one or more aspects of the present disclosure.

FIG. 2 shows an example of a wireless communications system that supports accuracy and capabilities for cross frequency-range beam prediction in accordance with one or more aspects of the present disclosure.

FIG. 3 shows an example of combination-specific accuracy requirements that supports accuracy and capabilities for cross frequency-range beam prediction in accordance with one or more aspects of the present disclosure.

FIG. 4 shows an example of accuracy requirements associated with reference signal characteristics that supports accuracy and capabilities for cross frequency-range beam prediction in accordance with one or more aspects of the present disclosure.

FIG. 5 shows an example of wireless device capabilities on beam sets that supports accuracy and capabilities for cross frequency-range beam prediction in accordance with one or more aspects of the present disclosure.

FIG. 6 shows an example of a process flow that supports accuracy and capabilities for cross frequency-range beam prediction in accordance with one or more aspects of the present disclosure.

FIGS. 7 and 8 show block diagrams of devices that support accuracy and capabilities for cross frequency-range beam prediction in accordance with one or more aspects of the present disclosure.

FIG. 9 shows a block diagram of a communications manager that supports accuracy and capabilities for cross frequency-range beam prediction in accordance with one or more aspects of the present disclosure.

FIG. 10 shows a diagram of a system including a device that supports accuracy and capabilities for cross frequency-range beam prediction in accordance with one or more aspects of the present disclosure.

FIGS. 11 and 12 show block diagrams of devices that support accuracy and capabilities for cross frequency-range beam prediction in accordance with one or more aspects of the present disclosure.

FIG. 13 shows a block diagram of a communications manager that supports accuracy and capabilities for cross frequency-range beam prediction in accordance with one or more aspects of the present disclosure.

FIG. 14 shows a diagram of a system including a device that supports accuracy and capabilities for cross frequency-range beam prediction in accordance with one or more aspects of the present disclosure.

FIGS. 15 through 17 show flowcharts illustrating methods that support accuracy and capabilities for cross frequency-range beam prediction in accordance with one or more aspects of the present disclosure.

### DETAILED DESCRIPTION

In some wireless communications systems, such as systems that support millimeter wave (mmW) communications (e.g., new radio (NR) systems), wireless communication devices (e.g., network entities, transmission/reception points (TRPs), user equipments (UEs)) may communicate via directional transmissions (e.g., beams). For example, communications between wireless devices operating within a wireless communications system may be carried out via beamforming. In such cases, some wireless devices (e.g., the network entities and the UEs) may support beamforming operations in which antenna elements (e.g., of an antenna array) may be used to generate directional beams for transmitting or receiving communications.

To support reliable communications between wireless devices, the wireless devices may perform beam management, which may refer to a set of Layer 1 (L1) and Layer 2 (L2) procedures used to establish and maintain an optimal or best available beam pair (e.g., a transmit beam and a receive beam). Such procedures may include, for example, beam switching, beam failure recovery, and beam sweeping. For example, a network entity may transmit one or more reference signals (e.g., channel state information (CSI) reference signals (CSI-RSs), synchronization signal blocks (SSBs)) to a UE as part of beam management, such that the one or more reference signals correspond to one or more beams. The UE may measure the one or more reference signals. In some cases, the UE may generate a CSI report based on the measurements. The CSI report may include beam management information, such as signal characteristics (e.g., reference signal received power (RSRP), signal-to-interference-plus-noise ratio (SINR)), channel state parameters, and the like, associated with the one or more beams. The network entity and the UE may determine one or more best beams to use for communications based on the measurements and the CSI report. For example, at initial access, the network entity and the UE may establish communications by selecting a best beam pair. After a connection has been established, the network entity and the UE may perform beam refinement and beam switching to switch to a best beam.

In some examples, the UE may utilize a predictive model (e.g., a machine learning algorithm, an artificial intelligence algorithm) to proactively predict a best one or more beams, a beam event (e.g., a beam switch event, a beam failure event), or measurements or characteristics of one or more beams for which the UE does not have resources (e.g., time resources, frequency resources, or processing resources) to physically measure. Using a predictive model in this way may reduce or eliminate overhead and latencies associated with beam management procedures. The predictive model may take as input one or more parameters, such as real-time channel measurements, past channel measurements, and side information (different from and in addition to the channel measurements), or a combination of these. For example, the UE may predict one or more signal characteristics (e.g., RSRP, SINR) of a second set of beams based on measurements of a first set of beams or based on an ideal value of the one or more signal characteristics.

In some examples, channel characteristic predictions may satisfy an accuracy requirement for the UE to implement beam management based on the channel characteristic predictions. The present disclosure provides accuracy requirements for cross-frequency range beam prediction. For example, an accuracy requirement for predicted signal characteristics may be based on the combination of the measurement frequency range and the prediction target frequency range. For example, the UE may communicate via a first set of beams in a first frequency, and the UE may predict channel characteristics for a second set of beams in a second frequency range based on performing measurements of the first set of beams. The combination of the first frequency range and the second frequency range may be associated with a corresponding accuracy level. Different combinations of frequency ranges may correspond to different accuracy levels or accuracy requirements. For example, a first accuracy requirement associated with the first frequency range as a measurement frequency range and the second frequency range as the prediction target frequency range may be different from a second accuracy requirement where the second frequency range is the measurement frequency range and a third frequency range is the prediction target frequency range.

In some examples, the accuracy requirements may be based on generic or ideal channel characteristics for the same resource. For example, the UE may compare a predicted channel characteristic for a resource to an ideal channel characteristic for that resource. Additionally, or alternatively, the accuracy requirements may be based on UE-measured channel characteristics. For example, the UE may compare a predicted channel characteristic for a resource to a previously-measured channel characteristic for that resource. In some examples, the UE may indicate a capability to support cross-frequency range accuracy requirements or cross-frequency range beam prediction, or both. In some examples, the UE may be configured with accuracy requirements for cross-frequency range predictions, cross-carrier predictions, cross-band predictions, or cross-sub-frequency range predictions (e.g., having a first accuracy requirement associated with a first portion of a first frequency range and a second frequency range and a second accuracy requirement associated with a second portion of the first frequency range and the second frequency range).

Particular aspects of the subject matter described herein may be implemented to realize one or more potential advantages by facilitating improved beam management procedures between the network entity and the UE. As such, the network entity may more optimally select a beam to use for communications between the network entity and the UE. The network entity and the UE may experience a greater likelihood for successful communications based on a more optimal beam selection, which may lead to greater system throughput, capacity, and spectral efficiency, as well as reduced signaling overhead between the network entity and the UE. In some examples, the described techniques may enable a network entity, or the UE, or both, to proactively switch active beams (e.g., one or more of a transmit beam or receive beam) in advance of a beam event (e.g., a beam failure event). In such cases, the network entity and the UE may experience reduced occurrences of beam failure recovery, as well as improved operational characteristics, such as reduced overhead signaling and decreased communications latency, among other benefits.

Aspects of the disclosure are initially described in the context of wireless communications systems. Aspects of the disclosure are further illustrated by and described with reference to apparatus diagrams, system diagrams, and flowcharts that relate to accuracy and capabilities for cross frequency-range beam prediction.

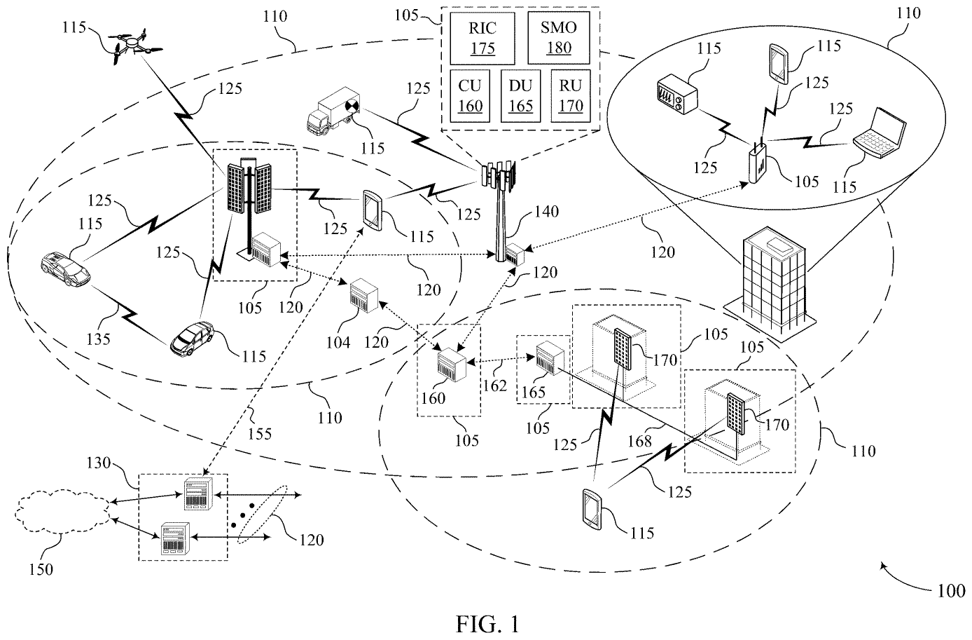

FIG. 1 shows an example of a wireless communications system 100 that supports accuracy and capabilities for cross frequency-range beam prediction in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support accuracy and capabilities for cross frequency-range beam prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The UE 115 and the network entity 105 may communicate using beamformed communications via one or more communications links, which may be examples of downlink channels (e.g., physical downlink shared channels (PDSCHs), physical downlink control channels (PDCCHs)), uplink channels (e.g., physical uplink shared channels (PUSCHs), physical uplink control channels (PUCCHs)), or the like. To support beamformed communications, the UE 115 and the network entity 105 may perform beam management. Beam management may include beam sweeping, in which the network entity 105 may cover the UE 115 with one or more transmission beams of a beam set. More specifically, the network entity 105 may sweep a set of transmission beams across the communication link according to a beam sweep pattern. In some examples, the beam sweeping pattern may include transmitting a set of SSBs or a set of CSI-RSs across the beam set. The UE 115 may perform measurements of the SSBs or CSI-RSs received across the beam set and transmit a report to the network entity 105 indicating information based on the measurements. For example, the report may indicate a strongest beam, an L1-RSRP, an L1-SINR, or the like. The UE 115 and the network entity 105 may select or reselect a best beam or adapt to a beam event (e.g., a beam failure event) based on the report.

Beam management procedures may be utilized during initial access procedures to establish communications over a communication link between the UE 115 and the network entity 105. Additionally, the UE 115 and the network entity 105 may implement beam management procedures to maintain or update communications via the communication link. In some cases, the UE 115 may operate in an idle mode (e.g., an RRC_IDLE mode) or an inactive mode (e.g., an RRC_INACTIVE mode). The network entity 105 and the UE 115 may perform an SSB beam sweep and report procedure during an initial access procedure (e.g., as part of a random access channel (RACH) procedure). Here, the network entity 105 may transmit a set of SSBs across a set of beams. The UE 115 may receive the SSBs and perform measurements to obtain beam information, such as signal strength measurements (e.g., RSRP, SINR), and may report the beam information to the network entity 105. Beams used for SSB beam sweeping may be wide beams (e.g., layer 1 (L1) beams). The UE 115 and the network entity 105 may select a best (e.g., strongest) beam from the swept beams for the communication link based on the measurements and the report.

After initial access, the UE 115 may operate in a connected mode (e.g., an RRC_CONNECTED mode) and may implement beam management procedures to maintain reliable communications via the communication link. For instance, the network entity 105 and the UE 115 may periodically perform a CSI-RS beam sweep and report procedure while in the connected mode. The CSI-RS beam sweep may be a P1, P2, or P3 procedure. P1 may be a beam selection procedure where the network entity 105 sweeps a beam set and the UE 115 selects a best (e.g., strongest) beam of the beam set. The UE 115 may report the selected beam to the network entity 105. P2 may be a beam refinement procedure for the network entity 105, where the network entity 105 may refine a beam (e.g., by sweeping a narrower beam over a narrower range), and UE 115 may detect and report the best beam to the network entity 105. P3 may be a beam refinement procedure for the UE 115, where the network entity 105 may fix a beam (e.g., transmit a same beam repeatedly), and UE 115 may refine its receiver beam. For example, the UE 115 may set a spatial filter on the antenna array of the UE 115. The UE 115 may transmit an L1 report for beam refinement. The network entity 105 and the UE 115 may perform same process for uplink beam management (e.g., U1, U2, and U3). Additionally, or alternatively, the network entity 105 and the UE 115 may perform a CSI-RS beam sweep and report procedure as part of a beam failure recovery procedure (e.g., to facilitate fast recovery) or a radio link failure procedure (e.g., as a last resort to re-establish communications).

The UE 115 and the network entity 105 may perform beam management, measurements, and reporting according to one or more accuracy requirements. An accuracy requirement may be defined for a measurement type (e.g., RSRP or SINR), a reference signal type (e.g., SSB or CSI-RS), and a frequency range. For example, accuracy requirements may be defined for RSRP values obtained by the UE 115 measuring SSBs (e.g., received via SSB resources configured for L1-RSRP measurements), which may be referred to as SSB-based L1-RSRP accuracy requirements. Other accuracy requirements may be defined for L1-RSRP measurements of CSI-RSs received at the UE 115 (e.g., via CSI-RS resources configured for L1-RSRP measurements), which may be referred to as CSI-RS-based accuracy requirements. Similarly, accuracy requirements may be defined for SSB-based L1-SINR measurements and for CSI-RS-based L1-SINR measurements. Additionally, in some cases, accuracy requirements may vary based a frequency bandwidth associated with the received reference signals, which may, in turn, be associated with different capabilities of the UE 115. For example, SSB-based L1-RSRP accuracy requirements may be separately defined for SSBs configured for L1-RSRP measurements in a first frequency range and SSBs configured for L1-RSRP measurements in a second frequency range.

The wireless communications system 100 may support accuracy requirements for cross-frequency range beam prediction. For example, an accuracy requirement for predicted signal characteristics may be based on both, or a combination of, the measurement frequency range and the prediction target frequency range. For example, a UE 115 may communicate via a first set of beams in a first frequency range, and the UE 115 may predict channel characteristics for a second set of beams in a second frequency range based on performing measurements of the first set of beams. The combination of the first frequency range and the second frequency range may be associated with a corresponding accuracy level. Different combinations of frequency ranges may correspond to different accuracy requirements.

In some examples, the accuracy requirements may be based on generic or ideal channel characteristics for the same resource. For example, the UE 115 may compare a predicted channel characteristic for a resource to an ideal channel characteristic for that resource. Additionally, or alternatively, the accuracy requirements may be based on UE-measured channel characteristics. In some examples, the UE 115 may indicate a capability to support cross-frequency range accuracy requirements or cross-frequency range beam prediction, or both. In some examples, the UE 115 may be configured with accuracy requirements for cross-frequency range predictions, cross-carrier predictions, cross-band predictions, or cross-sub-frequency range predictions.

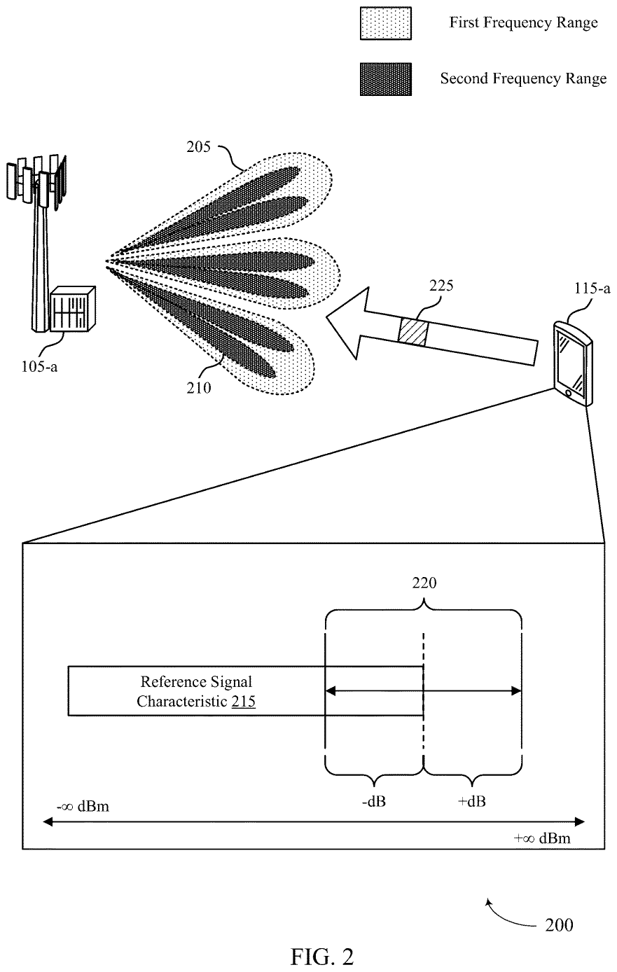

FIG. 2 shows an example of a wireless communications system 200 that supports accuracy and capabilities for cross frequency-range beam prediction in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a and a network entity 105-a, which may be examples of corresponding devices described with reference to FIG. 1.

The UE 115-a may perform artificial intelligence-based or machine learning-based beam prediction during beam management to predict a best beam or a beam event (e.g., a beam switch event, a beam failure event). The UE 115-a may use a predictive model (e.g., a machine learning algorithm) to perform beam prediction in a time domain, in a spatial domain, or both, to improve accuracy in beam selection. Beam prediction may involve the UE 115-a predicting a future best (e.g., top) beam index or a probability of a future best beam change. The UE 115-a may predict whether the best beam index may change (or change more dynamically) at a future time (or a future time window). Additionally, the UE 115-a may predict one or more signal characteristics, such as an RSRP or an SINR, for a target beam associated with a target one or more resources (e.g., time-frequency resources).

For example, for a target beam and a target one or more resources, the UE 115-a may utilize a predictive model to infer a signal characteristic that may be associated with communications via the target beam and the target one or more resources. The predictive model may be an example of a predictive model associated with beam management procedures. The UE 115-a may receive a message from the network entity 105-a that includes an indication of the target beam(s), the target one or more resources, or a combination thereof. The network entity 105-a may (e.g., via the message) indicate that the target one or more resources are to be used by the UE 115-a in predicting the signal characteristic for the target beam. Based on the indication(s), the UE 115-a may predict the signal characteristic for the target beam and the target one or more resources using the predictive model. In some cases, the UE 115-a may infer multiple signal characteristics corresponding to a target beam for a set of N future time instances. The UE 115-a may predict a respective signal characteristic for the beam for each future time instance.

Such predictions may utilize measurements of reference signals received via one or more other beams different from the target beam(s). For example, the UE 115-a may perform spatial-domain downlink beam prediction for a second beam set 210 based on measurement results of one or more reference signals received via a first beam set 205. Here, the network entity 105-a may transmit reference signals to the UE 115-a via the first beam set 205. The UE 115-a may receive and measure the reference signals and may utilize the measurements as inputs to a predictive model to predict one or more signal characteristics of one or more beams of the second beam set 210. In another example, the UE 115-a may perform time-domain beam prediction for the second beam set 210 based on historic (e.g., previously obtained) measurement results of the first beam set 205. In some examples, the first beam set 205 may be an example of Set-B beams, and the second beam set 210 may be an example of Set-A beams.

In some examples, the second beam set 210 may be a beam set associated with downlink beam prediction, while the first beam set 205 may be a beam set associated with downlink beam measurement (e.g., measurement of downlink reference signals received at the UE 115-a). In some examples, the first beam set 205 may include wide beams (e.g., beams having a wide beam width) while the second beam set 210 may include narrow beams (e.g., beams having a narrow beam width). The UE 115-a may, in some cases, select or otherwise determine a quantity of beams in the first beam set, a quantity of beams in the second beam set, or a combination thereof. Additionally, or alternatively, the UE 115-a may determine a quasi co-location (QCL) relation between one or more beams of the first beam set 205 and one or more beams of the second beam set 210.

In some examples, the UE 115-a may report information in a message 225 related to beam predictions to the network entity 105-a. For instance, the predictive model may output a beam of the second beam set 210 corresponding to a best beam and the UE 115-a may calculate (e.g., predict) a signal characteristic (e.g., RSRP, SINR) associated with the beam. The UE 115-a may transmit an indication of the beam (e.g., a beam index), an indication of the predicted signal characteristic, or a combination thereof, to the network entity 105-a in the message 225. For example, the UE 115-a may report a predicted L1-RSRP value, a predicted L1-SINR value, or a combination thereof, to the network entity 105-a in the message 225. In some cases, the UE 115-a may predict and report beam information (e.g., beam indexes, signal characteristics) associated with multiple beams or multiple predictions in the message 225.

The wireless communications system 200 may support accuracy requirements for beam prediction. An accuracy requirement 220 may correspond to a tolerance (e.g., a tolerance range) in dB for a predicted value of a reference signal characteristic 215 with respect to a reference value for the reference signal characteristic. The predicted value may be for a target beam and a target set of one or more resources, where the reference value is associated with the same target set of one or more resources. In some cases, accuracy requirements for UE-predicted values (e.g., L1-RSRP, L1-SINR) may be similar to those defined for UE-measured values (e.g., L1-RSRP, L1-SINR), but accuracy requirements for predicted values may have a relatively more relaxed tolerance.

As a specific example, an absolute accuracy requirement (e.g., an absolute accuracy tolerance) for an L1-RSRP prediction may be defined as RSRP_{predicted}-RSRP_{ref}, where RSRP_{predicted} denotes the predicted value of the L1-RSRP and RSRP_{ref} represents the reference value. Additionally, or alternatively, for a set of multiple target resources associated with multiple predictions, a relative accuracy requirement (e.g., a relative accuracy tolerance) for the L1-RSRP prediction may be defined as

$$( {RSRP}_{predicted}^{( 1 )} - {RSRP}_{predicted}^{( max )} ) - ( {RSRP}_{ref}^{( 1 )} - {RSRP}_{ref}^{( max )} ) .$$

### Here,

$${RSRP}_{predicted}^{( 1 )}$$

denotes a predicted value associated with a target resource of the set of multiple target resources,

$${RSRP}_{predicted}^{( max )}$$

refers to a strongest (e.g., maximum) predicted RSRP associated with a resource from among the set of multiple target resources,

$${RSRP}_{ref}^{( 1 )}$$

denotes a reference value for the target resource, and

$${RSRP}_{ref}^{( max )}$$

refers to a reference value for

$${RSRP}_{predicted}^{( max )}$$

that is associated with the same resource from among the set of multiple target resources. Similar accuracy requirements may be defined for other predicted reference signal characteristics, such as L1-SINR.

In some cases, the reference value may be an ideal value, such as a genie value. For a predicted RSRP associated with a target resource, the reference value may be an ideal RSRP value associated with the target resource. For a predicted SINR associated with a target resource, the reference value may be an ideal SINR value associated with the target resource. In other cases, the reference value may be an L1-RSRP value or an L1-SINR value obtained by the UE 115-a via measurements of one or more received reference signals associated with the target resource. Additionally, the target resource may be an SSB resource or a CSI-RS resource. For example, the UE 115-a may predict the reference signal characteristic 215 of a hypothetical reference signal, such as an SSB or a CSI-RS, that may be received (e.g., at a future time instance) via the target resource. Alternatively, the target resource may be referred to as a virtual resource that may not be used to transmit or receive, but may indicate additional information associated with the target beam, such as a beam shape or beam direction. In some cases, the additional information may indicate connection information, such as QCL information, with another one or more resources (e.g., SSB or CSI-RS resources).

In the example of FIG. 2, for instance, the UE 115-a may predict the reference signal characteristic 215, such as

$${SINR}_{predicted}^{( 1 )} ,$$

for a target beam of the second beam set in accordance with a relative accuracy requirement. The target beam may be associated with a target resource of a set of resources. The UE 115-a may obtain a reference value

$${SINR}_{ref}^{( 1 )}$$

for the relative accuracy requirement by measuring a downlink reference signal received via the first beam set that corresponds to the target resource. For example, the target resource may be an SSB resource. The UE 115-a may receive an SSB via a beam of the first beam set corresponding to the target resource and may measure the SSB to obtain

$${SINR}_{ref}^{( 1 )} .$$

Alternatively, the target resource may be an example of a virtual resource associated with a beam shape of the target beam, a beam direction of the target beam, or a combination thereof. In some cases, the virtual resource may indicate a correspondence between the downlink reference signal (e.g., and one or more other downlink reference signals associated with the first beam set) and a beam shape of the target beam, a correspondence between the downlink reference signal (e.g., and one or more other downlink reference signals associated with the first beam set) and a beam direction of the target beam, or a combination thereof. In some examples, the virtual resource may indicate a QCL correspondence between the downlink reference signal (e.g., and one or more other downlink reference signals associated with the first beam set) and the second beam set.

The UE 115-a may predict one or more additional reference signal characteristics for one or more additional beams of the second beam set 210 associated with the set of resources. The UE 115-a may determine a maximum value

$${SINR}_{predicted}^{( max )}$$

of the predicted one or more additional signal characteristics. Additionally, the UE 115-a may receive and measure one or more other downlink reference signals via the first beam set corresponding to the set of resources, and may determine a maximum value

$${SINR}_{ref}^{( max )}$$

from among all downlink reference signals received via the set of resources and measured by the UE 115-a. The UE 115-a may calculate the relative accuracy requirement for the predicted reference signal characteristic 215 in accordance with

$$( {SINR}_{predicted}^{( 1 )} - {SINR}_{predicted}^{( max )} ) - ( {SINR}_{ref}^{( 1 )} - {SINR}_{ref}^{( max )} ) .$$

The UE 115-a may transmit an indication of the predicted reference signal characteristic 215

$$( e . g . , {SINR}_{predicted}^{( 1 )} )$$

to the network entity 105-a (e.g., in the message 225) in accordance with the relative accuracy requirement.

Accuracy levels attainable by predictive models utilized for such predictions may be based on characteristics of the target beam(s) and characteristics of the beams associated with the received reference signals and the measured signal characteristics. For example, when the first beam set 205 includes a relatively large quantity of beams, the UE 115-a may be able to obtain sufficient measurement results such that associated predictions for the second beam set 210 have improved accuracy (e.g., compared to scenarios in which the first beam set 205 includes fewer beams). Thus, the accuracy requirements for UE predictions may also depend on such characteristics or conditions. In some cases, the accuracy requirement 220 may additionally, or alternatively, be based on a time duration between a target resource and the report transmitted by the UE 115-a. For instance, the UE 115-a may predict a signal characteristic for a target resource, but may wait to transmit a report indicating the prediction. In this case, the accuracy requirement 220 associated with the prediction may be less strict, as conditions may change during the time duration that may decrease the reliability and accuracy of the prediction. For shorter time durations between a prediction and a report, the accuracy requirement 220 may be stricter.

Computational capabilities or computational resources of a UE 115 may further affect accuracy levels that the UE 115 is capable of achieving. For example, a first UE 115 that has greater computational capabilities for machine learning or artificial intelligence-based procedures may be able to predict signal characteristics with greater accuracy than a second UE 115 with limited computational capabilities. As such, the first UE 115 meet stricter accuracy requirements than the second UE 115.

In some cases, a UE 115 may transmit a capability message indicating accuracy requirements that the UE 115 is able to achieve. In some examples, the UE 115 may receive a request for the capability message and may transmit the capability message in response to the request. In the example of FIG. 2, the UE 115-a may receive, from the network entity 105-a, a request for the UE 115-a to transmit a capability message. Based on the request, the UE 115-a may transmit, to the network entity 105-a, a capability message that includes an indication of one or more accuracy requirements supported by the UE 115-a for one or more reference signal characteristics to be predicted by the UE 115-a. For example, if the UE 115-a is to predict a set of reference signal characteristics for a target beam of the second beam set corresponding to a target resource, the UE 115-a may indicate, to the network entity 105-a, that the UE 115-a supports a set of accuracy requirements with respect to the set of reference signal characteristics. In some cases, the UE 115-a's capability to support the set of accuracy requirements may be based on the set of reference signal characteristics, a quantity of beams of the second beam set, or a beam type (e.g., SSB, CSI-RS) associated with the target beam or the second beam set, or a combination thereof. For instance, the UE 115-a may support a first subset of accuracy requirements for SSB-based RSRP measurements, a second subset of accuracy requirements for SSB-based SINR measurements, a third subset of accuracy requirements for CSI-RS-based RSRP measurements, and a fourth subset of accuracy requirements for CSI-RS-based SINR measurements.

Additionally, in some cases, the capability of the UE 115-a to support the set of accuracy requirements may be based on the reference value according to which the UE 115-a predicts the set of reference signal characteristics, e.g., based on whether the reference value is an ideal value or a measured value. When the UE 115-a performs the prediction based on a measured reference value, such as a measurement associated with the first beam set, the capability of the UE 115-a to support the set of accuracy requirements may be based on a quantity of beams of the first beam set 205, a beam type associated with the first beam set 205, one or more measured reference signal characteristics of the first beam set 205, or a combination thereof.

Reference signal characteristic predictions by a UE 115 may be associated with a confidence level based on the accuracy requirement 220. A confidence level may denote a likelihood that the prediction satisfies the accuracy requirement 220. For example, a 90% confidence level may indicate that a predicted signal strength requirement is 90% likely to be within a tolerance range of the accuracy requirement 220 (e.g., 90% of predictions by the UE 115 satisfy the accuracy requirement). In some cases, a UE 115 may report a confidence level along with a predicted reference signal characteristic in the message 225. In the example of FIG. 2, the UE 115-a may transmit the message 225 indicating a confidence level associated with predicting one or more signal characteristics for a beam (e.g., a target beam) of the second beam set. The confidence level may be based on the accuracy requirement 220, one or more capabilities of the UE 115-a (e.g., computational capabilities), the first beam set, the second beam set, or a combination thereof.

The wireless communications system 200 may support cross-frequency beam prediction based on an accuracy requirement associated with cross frequency-range beam prediction. For example, the UE 115-a may measure signal characteristics for the first beam set 205, which may be associated with the first frequency range. The UE 115-a may, based on the measured signal characteristics, predict signal characteristics for non-measured resources in a second frequency range. For example, the UE 115-a may predict signal characteristics for the second beam set 210, which may be associated with the second frequency range.

An accuracy requirement 220 for the predicted signal characteristics for the second beam set 210 may be based on the frequency ranges associated with the prediction (e.g., based on which frequency range is used for measurements and which frequency range is associated with the prediction). For example, the accuracy requirement 220 for the predicted signal characteristics may be based on the first frequency range and the second frequency range. Different combinations of frequency ranges may have different accuracy requirements. For example, signal characteristic predictions between the first frequency range and the second frequency range may have a different accuracy requirement than signal characteristic predictions between the second frequency range and a third frequency range.

In some examples, the accuracy requirement 220 may be based on a reference signal characteristic 215. The reference signal characteristic 215 may be an ideal signal characteristic for a predicted resource or a UE-measured signal characteristic for the predicted resource (e.g., from a previous measurement). If the predicted signal characteristic is within the accuracy requirement 220 of the reference signal characteristic 215, the predicted signal characteristic may be considered to satisfy the accuracy requirement 220. In some examples, the accuracy requirement 220 may be referred to as an error tolerance.

In some examples, the accuracy requirements may be based on a difference in frequency between the measured resources and the predicted resources. For example, a relatively small difference between measured resources in the first frequency range and predicted resources in the second frequency range may be associated with a higher prediction accuracy. Alternatively, a relatively large difference in frequency between measured resources in the first frequency range and predicted resources in the second frequency range may be associated with a lower prediction accuracy. In some examples, the UE 115-a may perform additional measurements in the first frequency range, use additional auxiliary reference signals on the beam set, or both to predict a signal characteristic within the accuracy requirement 220.

In some examples, the UE 115-a may have accuracy requirements for cross-frequency range beam predictions, cross-band beam predictions, cross-carrier beam predictions, or any combination thereof. The term radio frequency spectrum may refer to an FR, a portion of an FR, a component carrier, a radio frequency spectrum band, or any combination. In some cases, the first frequency range may correspond to, for example, at least one of FR1, FR2, FR3, or FR4, while the second frequency range corresponds to a different frequency range than the first frequency range. In some examples, a frequency range may be divided into multiple sub-FRs for cross-sub-FR beam predictions. For example, FR2 may be divided into a first portion and a second portion. The UE 115-a may be configured with an accuracy requirement associated with the first portion of FR2 (e.g., as the measurement frequency spectrum) and the second portion of FR 2 (e.g., as the prediction target frequency spectrum. Additionally, or alternatively, the UE 115-a may be configured with an accuracy requirement associated with the first portion of FR2 (e.g., as the measurement frequency spectrum) and FR4 (e.g., as the prediction target frequency spectrum, or an accuracy requirement associated with the second portion of FR2 (e.g., as the measurement frequency spectrum) and FR4 (e.g., as the prediction target frequency spectrum.

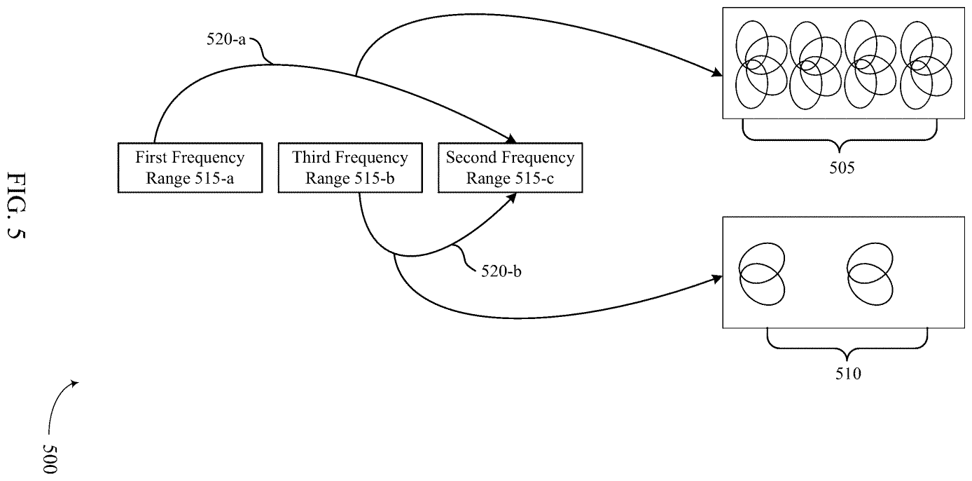

In some cases, the wireless device may report the capability of the wireless device to predict the one or more predicted signal characteristics associated with the combination of the first frequency range and the second frequency range. For example, the capability of the wireless device may be based on the combination of the first frequency range and the second frequency range and the characteristics of the first beam set, the second beam set, or both. Some additional aspects of capability signaling are described in more detail with reference to FIG. 5.

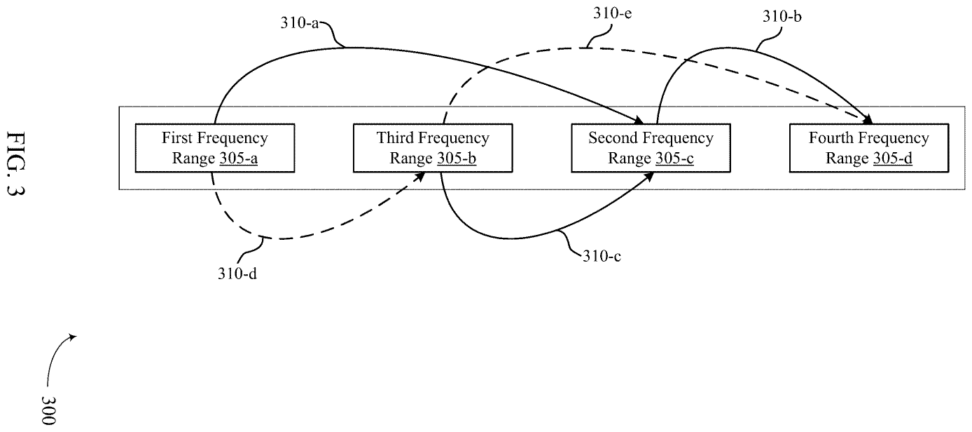

FIG. 3 shows an example of combination specific accuracy requirements 300 that supports accuracy and capabilities for cross frequency-range beam prediction in accordance with one or more aspects of the present disclosure. In some examples, the combination specific accuracy requirements 300 may implement aspects of the wireless communications system 100 or may be implemented by aspects of the wireless communications system 100. For example, the combination specific accuracy requirements may be used by a UE 115 and a network entity 105 to predict signal characteristics of a second radio frequency spectrum based on measured signal characteristics of a first radio frequency spectrum.

For example, a UE 15 may monitor for one or more reference signals via a first set of one or more beams. The first set of one or more beams may be associated with a first radio frequency spectrum. The UE 115 may measure signal characteristics of one or more reference signals via the first set of one or more beams. For example, the wireless device may measure an RSRP or an SINR of the one or more reference signals via the first set of one or more beams. The UE 115 may predict one or more signal characteristics for a second set of one or more beams associated with a second radio frequency spectrum based on the measured signal characteristics associated with the first radio frequency spectrum. For example, a first radio frequency spectrum may correspond to a measured radio frequency spectrum, and the second frequency spectrum may correspond to a predicted radio frequency spectrum (e.g., a prediction target radio frequency spectrum), or a frequency spectrum with resources for which the wireless device predicts channel characteristics or signal characteristics. For example, the wireless device may predict RSRP, SINR, or the top candidate beams (e.g., beam identifiers or directions for a configured quantity of the top candidate beams) for the second radio frequency spectrum based on measurements made for the first radio frequency spectrum.

In some cases, the measured radio frequency spectrum and the predicted radio frequency spectrum may each correspond to a frequency range. For example, the measured radio frequency spectrum may correspond to a first frequency range 305-a, and the predicted radio frequency spectrum may correspond to a third frequency range 305-b. In some other examples, the measured radio frequency spectrum may correspond to a third frequency range 305-b, and the predicted radio frequency spectrum may correspond to a second frequency range 305-c. In some other examples, the measured radio frequency spectrum may correspond to a second frequency range 305-c, and the predicted radio frequency spectrum may correspond to a fourth frequency range 305-d.

In some examples, the first frequency range 305-a may correspond to FR1, the third frequency range 305-b may correspond to FR3, the second frequency range 305-c may correspond to FR2, and the fourth frequency range 305-d may correspond to FR4. For example, the UE 115 may predict channel characteristics for FR2 based on measurements of FR1, predicted channel characteristics for FR2 based on measurements of FR3, or predicted channel characteristics for FR4 based on measurements of FR2, or any combination thereof. These pairs of measurement and prediction radio frequency spectrums are exemplary, and other combinations of measurement radio frequency spectrums and prediction radio frequency spectrums may be supported. In some other examples, the frequency ranges 305 may be examples of radio frequency spectrums and may be exemplary of bands, component carriers, or sub-ranges of FRs.

In some cases, the predicted signal characteristics for cross-FR beam prediction may be associated with an accuracy requirement. In some examples, to transmit a report indicating the predictions or to perform beam management based on predictions, the UE 115 may need to satisfy an accuracy requirement associated with the predictions.

In some examples, an accuracy requirement may be based on a measured radio frequency spectrum and a predicted radio frequency spectrum. In some examples, different combinations of measured radio frequency spectrums and predicted radio frequency spectrums may be associated with different accuracy levels or accuracy requirements. For example, the wireless device may measure signal characteristics via the first set of one or more beams in the first frequency range 305-a and predict signal characteristics for the second set of one or more beams in the second frequency range 305-c. In some cases, the accuracy requirement 310-a may be specific to the combination of measuring signal characteristics in the first frequency range 305-a and predicting characteristics in the second frequency range 305-c. For example, the accuracy requirement 310-a may be an RSRP prediction error tolerance range (e.g., +15 dB).

In some examples, the UE 115 may measure signal characteristics via the first set of one or more beams in the second frequency range 305-c and predict signal characteristics for the second set of one or more beams in the fourth frequency range 305-d. In some cases, an accuracy requirement 310-b may be specific to the combination of measuring signal characteristics in the second frequency range 305-c and predicting characteristics in the fourth frequency range 305-d. For example, the accuracy requirement 310-b may be an RSRP prediction error tolerance range (e.g., ±10 dB).

In some examples, the UE 115 may measure signal characteristics via the first set of one or more beams in the third frequency range 305-b and predict signal characteristics for the second set of one or more beams in the second frequency range 305-c. In some cases, an accuracy requirement 310-c may be specific to the combination of measuring signal characteristics in the third frequency range 305-b and predicting characteristics in the second frequency range 305-c. For example, the accuracy requirement 310-c may be an RSRP prediction error tolerance range (e.g., ±12 dB).

In some examples, the UE 115 may measure signal characteristics via the first set of one or more beams in the first frequency range 305-a and predict signal characteristics for the second set of one or more beams in the third frequency range 305-b, and the predicted channel characteristics for the beams in the third frequency range 305-b may be based on an accuracy requirement 310-d. In some examples, the UE 115 may measure signal characteristics via the first set of one or more beams in the third frequency range 305-b and predict signal characteristics for the second set of one or more beams in the fourth frequency range 305-d, and the predicted channel characteristics for the beams in the fourth frequency range 305-d may be based on an accuracy requirement 310-e. In some examples, the UE 115 may not perform predictions using a combination of the first frequency range 305-a and the third frequency range 305-b or using a combination of the third frequency range 305-b and the fourth frequency range 305-d, as the difference in frequency may be too great to perform an accurate prediction.

In some examples, supported pairs of radio frequency spectrums for cross-radio frequency spectrum beam prediction may be predefined, preconfigured, or configured. For example, one or more pairs of radio frequency spectrums, each including a measurement radio frequency spectrum and a predicted radio frequency spectrum, may be predefined, preconfigured, or configured at the UE 115. For example, a network entity 105 may indicate supported pairs of radio frequency spectrums via system information. For example, the UE 115 may be configured with at least one pair of FRs for cross-FR beam prediction, including FR1 as a measurement radio frequency spectrum and FR2 as a predicted radio frequency spectrum. Additionally, or alternatively, an accuracy requirement 310 associated with each pair may be predefined, preconfigured, or configured, or any combination thereof. For example, a network entity 105 may indicate accuracy requirements 310 via system information.

In some cases, a network entity 105 may select, from a subset of predefined combination-specific accuracy options, an accuracy requirement for the combination of a measured frequency range and a predicted frequency range. For example, a UE 115 may receive a control message that configures the UE 115 to predict the one or more predicted signal characteristics based on the control message. The control message may identify the first radio frequency spectrum and the second frequency spectrum for predicting the one or more predicted signal characteristics. For example, the control message may identify a first frequency range 305-a and a second frequency range 305-c. In some examples, the network entity 105 may transmit a system information message that configures the UE 115 to predict the one or more predicted signal characteristics. In some cases, the control message may indicate the accuracy requirement that is associated with the first radio frequency spectrum and the second radio frequency spectrum. For example, the control message may indicate the accuracy requirement 310-a that is associated with the first frequency range 305-a (as the measurement radio frequency spectrum) and the second frequency range 305-c (e.g., as the predicted radio frequency spectrum or the prediction target radio frequency spectrum).

In some cases, the UE 115 may further report capabilities associated with the number, type, quality, or a combination thereof of the first set of one or more beams, the second set of one or more beams, or both. In some cases, the reporting may be based on the accuracy requirement associated with the combination of the measured frequency range and the predicted frequency range. For example, the UE 115 may further report capabilities in order to achieve the accuracy level requirement.

In some cases, the accuracy requirement may be based on the relative difference between the measured frequency range and the predicted frequency range. For example, a relatively small difference between the measured frequency range and the predicted frequency range may correspond to a stricter accuracy requirement while a relatively large difference between the measured frequency range and the predicted frequency range may correspond to a less strict accuracy requirement.

In some examples, an FR or a radio frequency spectrum may be divided into multiple sub-FRs or multiple sub-radio frequency spectrums. For example, the second frequency range 305-c may be divided into a first sub-portion (e.g., a first sub-portion of FR2 ranging from 24 GHz to 50 GHz) and a second sub-portion (e.g., a second sub-portion of FR2 ranging from 60 GHz to 81 GHZ). In some cases, the accuracy requirement and capability reporting may be based on the combination of sub-portions of frequency ranges with frequency ranges or other sub-portions of frequency ranges. For example, the UE 115 may be configured with an accuracy requirement associated with performing measurements on the first sub-portion of FR2 to predict channel characteristic for the second sub-portion of FR2. In some examples, the UE 115 may be configured an accuracy requirement associated with performing measurements on the first sub-portion of FR2 to predict channel characteristics for FR4. In some examples, the UE 115 may be configured an accuracy requirement associated with performing measurements on the second sub-portion of FR2 to predict channel characteristics for FR4. In some examples, the UE 115 may be configured an accuracy requirement associated with performing measurements on FR3 to predict channel characteristics for the first sub-portion of FR2. In some examples, the UE 115 may be configured an accuracy requirement associated with performing measurements on FR3 to predict channel characteristics for the second sub-portion of FR2. In some examples, the UE 115 may transmit a control message indicating a capability of the UE 115 to support cross-sub-FR beam predictions. In some examples, the UE 115 may indicate a capability to support predictions for any one or more of the pairs with a sub-FR.

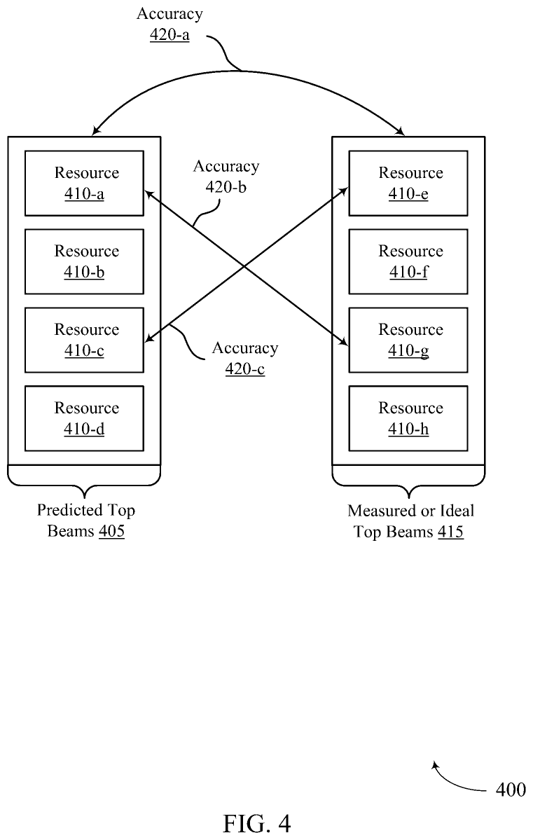

FIG. 4 shows an example of prediction accuracy configurations 400 that supports accuracy and capabilities for cross frequency-range beam prediction in accordance with one or more aspects of the present disclosure. In some examples, the accuracy requirements associated with reference signal characteristics may implement aspects of the wireless communications system 100 or 200 or may be implemented by aspects of the wireless communications system 100 or 200.

For example, a UE 115 may predict one or more predicted signal characteristics of a second set of one or more beams based on one or more measured signal characteristics of a first set of one or more beams. The UE 115 may transmit an indication of the predicted signal characteristics based on an accuracy requirement that is associated with the first radio frequency spectrum, the second radio frequency spectrum, and one or more reference signal characteristics. For example, the indication of the predicted signal characteristics may be based on accuracy requirements associated with reference signal characteristics. In some examples, the accuracy requirement associated with a reference signal characteristic may be defined according to a tolerance for the predicted signal characteristic.

For example, a UE 115 may predict one or more predicted signal characteristics which satisfy the accuracy requirement based on the one or more predicted signal characteristics being within a threshold difference from the one or more measured signal characteristics. In some cases, the one or more reference signal characteristics may correspond measured signal characteristics. For example, the tolerance (e.g., ±dB) for the one or more predicted signal characteristics (e.g., RSRP, SINR) of a resource may be based on one or more measured signal characteristics (e.g., RSRP, SINR) associated with the same resource.

Additionally, or alternatively, the wireless device may predict the one or more predicted signal characteristics which satisfy the accuracy requirement based on the one or more predicted signal characteristics being within a threshold difference from one or more ideal signal characteristics. In some cases, the one or more reference signal characteristics may correspond to the one or more ideal signal characteristics. For example, the tolerance (e.g., ±dB) for the one or more predicted signal characteristics (e.g., RSRP, SINR) of a resource may be based on one or more ideal (e.g., generic, genie, actual) signal characteristics (e.g., RSRP, SINR) of the same resource.

An accuracy 420 for the top beams may be determined based on different metrics. In the example of FIG. 2, a UE 115 may identify a top 4 beams, but in other examples, the UE 115 may identify a different quantity of top beams (e.g., using a different quantity of K). In some cases, a UE 115 may predict the one or more predicted signal characteristics which satisfy the accuracy requirement based on time-frequency resources associated with the one or more predicted signal characteristics corresponding to time-frequency resources associated with each of the one or more reference signal characteristics. For example, a resource 410-a, a resource 410-b, a resource 410-c, and a resource 410-d (e.g., top-K resources) may be associated with predicted top beams 405 (e.g., top-K predicted beams). Similarly, a resource 410-e, a resource 410-f, a resource 410-g, and a resource 410-h (e.g., UE measured top-K resources, ideal top-K resources) may be associated with measured or ideal top beams 415. In some cases, a resource of the predicted top beams 405 may correspond to a resource of the measured or ideal top beams 415 according to an accuracy 420-a. For example, the accuracy 420-a may be based on a probability of UE-predicted top-K resources (e.g., in terms of RSRP or SINR) being the reference top-K resources (e.g., ideal or UE-measured top-K resources).

In some cases, a wireless device may predict the one or more predicted signal characteristics which satisfy the accuracy requirement based on a time-frequency resource associated with highest predicted signal characteristic of the one or more predicted signal characteristics corresponding to a time-frequency resource associated with any of the one or more reference signal characteristics. For example, the resource 410-a of the predicted top beams 405 may correspond to a resource of the measured or ideal top beams 415 (e.g., the resource 410-g) according to an accuracy 420-b. For example, the accuracy 420-b may be based on a probability of a top-1 UE-predicted resource (e.g., in terms of RSRP or SINR) being within the reference top-K resources (e.g., ideal or UE-measured top-K resources).

In some cases, a wireless device may predict the one or more predicted signal characteristics which satisfy the accuracy requirement based on a time-frequency resource associated with a highest reference signal characteristic of the one or more reference signal characteristics corresponding to a time-frequency resource associated with any of the one or more predicted signal characteristics. For example, the resource 410-e of the measured or ideal top beams 415 may correspond to a resource of the predicted top beams 405 (e.g., the resource 410-c) according to an accuracy 420-c. For example, the accuracy 420-c may be based on a probability of a top-1 reference resource (e.g., ideal or UE-measured top-1 resource) being within the predicted top-K resources (e.g., in terms of RSRP or SINR).

In some cases, the UE 115 may be configured with multiple accuracy requirements. Each respective accuracy requirement of the multiple accuracy requirements may be based on a first respective radio frequency spectrum associated with measurements and a second respective radio frequency spectrum associated with signal characteristic predictions. For example, the UE 115 may report a predicted signal characteristic accuracy level within a range according to the accuracy requirement corresponding to the combination of the first radio frequency spectrum and the second radio frequency spectrum, an accuracy level of the multiple accuracy level options, or both. In some cases, the UE 115 may report the predicted signal characteristic accuracy level may be based on the wireless device's capability associated with the combination of the first radio frequency spectrum and the second radio frequency spectrum.

FIG. 5 shows an example of beam set configurations 500 that supports accuracy and capabilities for cross frequency-range beam prediction in accordance with one or more aspects of the present disclosure. In some examples, the beam set configurations 500 may implement aspects of the wireless communications system 100 or may be implemented by aspects of the wireless communications system 100.

For example, a UE 115 may predict one or more predicted signal characteristics of a second set of one or more beams based on one or more measured signal characteristics of a first set of one or more beams. The UE 115 may transmit an indication of the predicted signal characteristics based on an accuracy requirement that is associated with the first radio frequency spectrum, the second radio frequency spectrum, and one or more reference signal characteristics. In some cases, the indication of the predicted signal characteristics may be extended to include an additional indication of the wireless device capability to predict the one or more predicted signal characteristics. In some cases, the UE 115 o may transmit the additional indication of the wireless device capability based on the wireless device capabilities on beam sets.

In some cases, a UE 115 may transmit a control message indicating a capability of the UE 115 to predict the one or more predicted signal characteristics associated with the first radio frequency spectrum and the second radio frequency spectrum. In some cases, the combination of the first radio frequency spectrum and the second radio frequency spectrum may be associated with an accuracy requirement. For example, the combination of a first frequency range 515-a and a second frequency range 515-c may be associated with an accuracy requirement 520-a. Similarly, the combination of a third frequency range 515-b with the second frequency range 515-c may be associated with an accuracy requirement 520-b.

Additionally, or alternatively, the accuracy requirement may be based on characteristics (e.g., a quantity, type, or quality) of the first set of one or more beams, the second set of one or more beams, or both. In some cases, the characteristics (e.g., the quantity, type, or quality) of the first set of one or more beams and the second set of one or more beams may each be associated with prediction accuracy requirement levels. In some cases, the prediction accuracy requirement levels may be predefined.

For a radio frequency spectrum pair, including a measurement radio frequency spectrum and a prediction radio frequency spectrum, the UE 115 may report a minimum requirement on the associated quantity, type, or quality of measurement beams and prediction beams. For example, the UE 115 may report a minimum requirement for an associated quantity, type, or quality of Set-A beams or Set-B beams, or both.

In some cases, the UE 115 may report the capability of the UE 115 to predict the one or more predicted signal characteristics associated with the combination of the first radio frequency spectrum and the second radio frequency spectrum. In some examples, the capability of the wireless device may be based on the combination of the first radio frequency spectrum and the second radio frequency spectrum and the characteristics of the first set of one or more beams or the second set of one or beams, or both.

In some cases, the control message may indicate the capability of the wireless device to predict the one or more predicted signal characteristics based on beams of the second set of one or more beams having a narrower beam width than beams of the first set of one or more beams, the beams of the second set of one or more beams being more frequently transmitted than the beams of the first set of one or more beams, a time duration between predicting the one or more predicted signal characteristics and a time associated with the one or more predicted signal characteristics, or predicted signal characteristics being greater than measured signal characteristics, or any combination thereof. In some cases, the control message may indicate the capability of the wireless device to predict the one or more predicted signal characteristics based on a quantity of beams in the first set of one or more beams or the second set of one or more beams, a beam width of the beams in the first set of one or more beams or in the second set of one or more beams, a frequency of the beams in the first set of one or more beams or the second set of one or more beams, or any combination thereof.

When the difference between the first radio frequency spectrum and the second radio frequency spectrum is greater, the capabilities of the UE 115 to achieve a same accuracy level, or conditions for the UE 115 to achieve the same accuracy level, may be different. In some examples, the reported capabilities may be based on configurations for the measurement beams or the predicted beams, or both. For example, the difference between the first radio frequency spectrum and the second radio frequency spectrum may be relatively large (e.g., compared to a case in which the difference between the first radio frequency spectrum and the second radio frequency spectrum may be relatively small). In some cases, the relatively large difference may be associated with a less strict accuracy requirement (e.g., while the relatively small difference may be associated with a stricter accuracy requirement). Further, the capability of the wireless device to achieve the accuracy level may improve based on the beams of the second set of the one or more beams having a narrower beam width than beams of the first set of one or more beams (e.g., due to wider beams being associated with more evaluations in order to justify), the second set of one or more beams being more frequently transmitted than the first set of one or more beams (e.g., the first set of one or more beams may be transmitted as auxiliary reference signals for performance monitoring), a shorter time duration between predicting the one or more predicted signal characteristics (e.g., for frequency domain or time domain prediction), predicted signal characteristics being greater than measured signal characteristics (e.g., an RSRP or SINR of the second set of one or more beams being greater than an RSRP or SINR of the first set of one or more beams), or any combination thereof.

For example, the combination of the first frequency spectrum and the second frequency spectrum, characteristics of the first set of one or more beams and the second set of one or more beams, or both may be adjusted such that varying combinations of frequency spectrums yield a same accuracy requirement. For example, the combination of the first frequency range 515-a, the second frequency range 515-c, and a large quantity of beams 505 may be associated with the accuracy requirement 520-a. The accuracy requirement 520-b may be the same as the accuracy requirement 520-b based on the combination of the third frequency range 515-b, the second frequency range 515-c, and a small quantity of beams 510. For example, due to a difference between the first frequency range 515-a and the second frequency range 515-c being greater than a difference between the third frequency range 515-b and the second frequency range 515-c, the UE 115 may need to use more set-B beams, or measurement beams, in the spatial and frequency domain to achieve a similar accuracy level. Because there is a smaller difference in frequency between the third frequency range 515-b and the second frequency range 515-c, the UE 115 may be able to use fewer set-B beams, or measurement beams, in the spatial and frequency domain to satisfy the accuracy requirement.

Similarly, if there is a larger difference in frequency between the measurement radio frequency spectrum and the prediction radio frequency spectrum, the UE 115 may perform predictions for a smaller quantity of beams, or set-A beams, to satisfy the accuracy requirement. In some examples, if there is a larger difference in frequency between the measurement radio frequency spectrum and the prediction radio frequency spectrum, the measurement beams may be relative narrower or the predicted beams may be relatively wider to satisfy the accuracy requirement. In some examples, if there is a larger difference in frequency between the measurement radio frequency spectrum and the prediction radio frequency spectrum, the measurement beams may be transmitted with a higher frequency to satisfy the accuracy requirement, or the predicted beams may be transmitted (e.g., as auxiliary reference signals for performance monitoring), or the predicted beams may be more frequently transmitted.

For frequency domain and time domain predictions with a larger difference between the measured radio frequency spectrum and the predicted radio frequency spectrum, the UE may predict characteristics associated with a closer future time domain occasion to satisfy the accuracy requirements. For example, the lager the difference in frequency between the measured radio frequency spectrum and the predicted radio frequency spectrum, the shorter the time difference between the measurement and the prediction in order to satisfy the accuracy requirement. In some examples, the UE 115 may need a greater SINR measurement or RSRP measurement of the measurement beams in order to satisfy the accuracy requirement associated with a large difference between the measurement radio frequency spectrum and the predicted radio frequency spectrum.

In some cases, the relative difference between the first frequency spectrum and the second frequency spectrum may be relatively small. For example, the frequency of the first set of one or more beams may be the third frequency range 515-b while the frequency of the first set of one or more beams may be the second frequency range 515-c. In some cases, the combination of the third frequency range 515-b and the second frequency range 515-c may be associated with the accuracy requirement 520-b (e.g., ±12 dB). In some cases, the second set of one or more beams (e.g., the predicted beams) may be the small quantity of beams 510. For example, the wireless device may be capable of achieving the accuracy requirement 520-b with the small quantity of beams 510 based on the small relative difference between the third frequency range 515-b and the second frequency range 515-c.

Additionally, or alternatively, the relative difference between the first frequency spectrum and the second frequency spectrum may be relatively large. For example, the frequency of the first set of one or more beams may be the first frequency range 515-a while the frequency of the first set of one or more beams may be the second frequency range 515-c. Further, the combination of the first frequency range 515-a and the second frequency range 515-c may be associated with the accuracy requirement 520-a (e.g., ±15 dB). In some cases, the capability of the wireless device to predict the one or more predicted signal characteristics may be improved (e.g., the tolerance of the accuracy requirement may be reduced to ±12 dB) by the second set of one or more beams being a large quantity of beams 505. For example, the quantity of beams in the second set of one or more beams may be greater than the quantity of beams in the first set of one or more beams. In some cases, the large quantity of beams 505 in the second set of one or more beams may enable the wireless device to achieve the accuracy requirement 520-a, which may be the same as the accuracy requirement 520-b.

In some cases, the control message may indicate the capability of the wireless device to predict the one or more predicted signal characteristics based on a multiple of pairs of radio frequency spectrums including at least a first pair of the first radio frequency spectrum and the second radio frequency spectrum. For example, the multiple of pairs of radio frequency spectrums may include the first frequency range 515-a and the second frequency range 515-c, the third frequency range 515-b and the second frequency range 515-c, or both.

In some cases, the wireless device may transmit an indication of an updated capability of the wireless device to predict the one or more predicted signal characteristics. For example, the wireless device may dynamically update capability of the wireless device (e.g., the UE may dynamically update the UE capability and report the updated UE capability to the network entity). In some cases, the dynamic updates may be transmitted via RRC, MAC-CE, or UCI. In some cases, the updated capability of the wireless device may be based on a change to channel conditions, a change to resource availability at the UE, a change to the accuracy requirement, or any combination thereof.

In some cases, the wireless device may transmit a request for an increased quantity of reference signals via the first set of one or more beams to predict the signal characteristics. Additionally, or alternatively, the request for the increased quantity of reference signals may identify a CSI report setting associated with the first set of one or more beams. For example, a wireless device may request more auxiliary reference signals than initially requested. In some cases, the request may be applied to the CSI report setting. The CSI report setting may be included in a dedicated MAC-CE including a CSI report setting identifier or included in the CSI report including the prediction results.

For example, a UE 115 may be requested by a network entity 105 to predict and report prediction results based on a cross-FR beam prediction configuration. The initial configuration may use predefined accuracy levels or accuracy requirements. The UE 115 may, for example, be using machine learning resources (e.g., processing power or utilization) for a more urgent task, and the UE 115 may transmit a capability update to the network entity 105 based on the UE 115 having limited availability or machine learning processing resources. In some examples, the UE 115 may request additional auxiliary reference signals (e.g., more than initially reported in a capability message) to improve prediction accuracy. In some examples, the request may be associated with a specific CSI report setting. For example, the network entity 105 may transmit the additional auxiliary reference signals via resources associated with the CSI report setting based on the request.

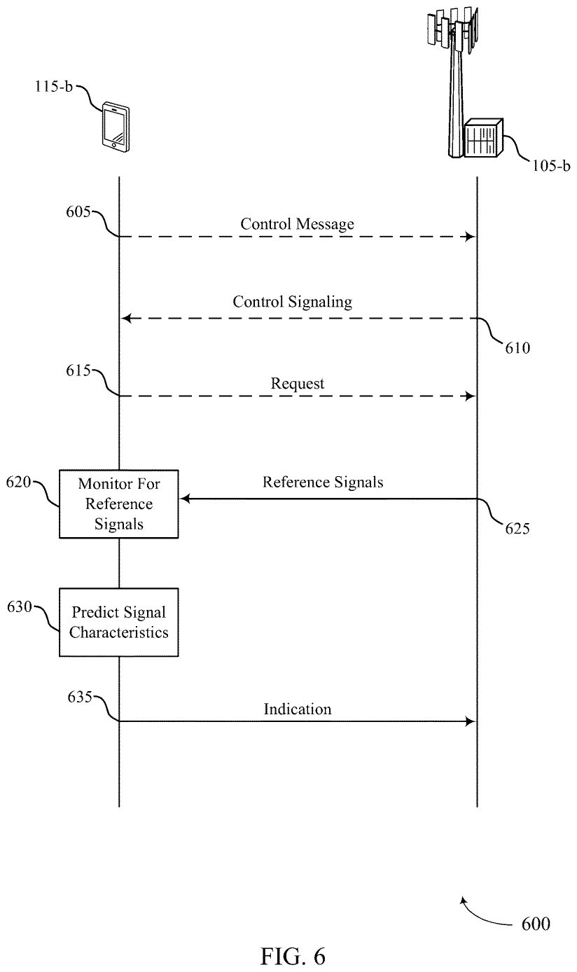

FIG. 6 shows an example of a process flow 600 that supports accuracy and capabilities for cross frequency-range beam prediction in accordance with one or more aspects of the present disclosure. In some examples, process flow 600 may implement aspects of wireless communications system 100. For example, the process flow 600 may include a UE 115-b and a network entity 105-b, which may be examples of corresponding devices described with reference to FIG. 1. In the following description of the process flow 600, the operations between the UE 115-b and the network entity 105 b may be transmitted in a different order than the example order shown, or the operations performed by the UE 115-b and the network entity 105-b may be performed in different orders or at different times. Some operations may also be omitted from the process flow 600, and other operations may be added to the process flow 600.

In some cases, the UE 115-b may predict one or more predicted signal characteristics of a second set of one or more beams based on one or more measured signal characteristics of a first set of one or more beams and transmit an indication of the predicted signal characteristics based on an accuracy requirement that is associated with the first radio frequency spectrum, the second radio frequency spectrum, and one or more reference signal characteristics.

In some cases, the first radio frequency spectrum may correspond to a first FR, and the second radio frequency spectrum may correspond to a second FR. For example, the UE 115-b may perform predictions for a second FR based on measurements in a first FR, and the UE 115-b may determine whether the predictions satisfy an accuracy requirement that is associated with the first FR and the second FR. The first FR may be, for example, FR1, FR2, or FR3. The second FR may be, for example, FR2, FR3, or FR4. In some cases, the first radio frequency spectrum may correspond to a first sub-portion of the first frequency range, and the second radio frequency spectrum may correspond to a second sub-portion of the second frequency range. For example, an FR may be divided into one or more portions or sub-ranges of the FR. In some examples, FR2 may be divided into two sub-ranges, with a first sub-rang of FR2 going from 24 GHz to 50 GHz, and a second sub-range of FR2 going from 60 GHz to 81 GHz. In some examples, the UE 115-b may support cross-radio frequency spectrum beam prediction based on a sub-range of an FR, such making predictions for FR4 based on the first sub-range of FR2. In some examples, different sub-ranges may be associated with different accuracy requirements. For example, an accuracy requirement where the first sub-range of FR2 is the prediction target may be different from an accuracy requirement where the second sub-range of FR2 is the prediction target (e.g., with a same measurement radio frequency spectrum). In some cases, the first radio frequency spectrum may correspond to a first radio frequency spectrum band, and the second radio frequency spectrum may correspond to a second radio frequency spectrum band. For example, these techniques for accuracy requirements may be implemented for cross-band beam prediction or cross-carrier beam prediction.

At 605, the UE 115-b may transmit, to the network entity 105-b, a control message. For example, the control message may indicate a capability of the UE 115-b to predict the one or more predicted signal characteristics associated with the first radio frequency spectrum and the second radio frequency spectrum. For example, the UE 115-b may indicate characteristics of a set of measurement beams in the first radio frequency spectrum or of a set of predicted beams in the second radio frequency spectrum to meet an accuracy requirement. For example, the UE 115-b may indicate that, to satisfy the accuracy requirement associated with the first radio frequency spectrum and the second radio frequency spectrum, the set of measurement beams (e.g., set-B beams) or the set of predicted beams (e.g., set-A beams) need to have certain quantities of beams, widths of beams, types, frequencies, or any combination thereof.

In some cases, the control message may indicate the capability of the UE 115-b to predict the one or more predicted signal characteristics based on beams of the second set of one or more beams having a narrower beam width than beams of the first set of one or more beams, the beams of the second set of one or more beams being more frequently transmitted than the beams of the first set of one or more beams, a time duration between predicting the one or more predicted signal characteristics and a time associated with the one or more predicted signal characteristics, or predicted signal characteristics being greater than measured signal characteristics, or any combination thereof. Additionally, or alternatively, the control message may indicate the capability of the UE 115-b to predict the one or more predicted signal characteristics based on a quantity of beams in the first set of one or more beams or the second set of one or more beams, a beam width of the beams in the first set of one or more beams or in the second set of one or more beams, a frequency of the beams in the first set of one or more beams or the second set of one or more beams, or any combination thereof. Additionally, or alternatively, the control message may indicate the capability of the UE 115-b to predict the one or more predicted signal characteristics based on multiple pairs of radio frequency spectrums including at least a first pair of the first radio frequency spectrum and the second radio frequency spectrum.

At 610, the UE 115-b may receive, from the network entity 105-b, control signaling. For example, the control signaling may include a control message that configures the UE 115-b to predict the one or more predicted signal characteristics. In some cases, the control message may identify the first radio frequency spectrum and the second radio frequency spectrum for predicting the one or more predicted signal characteristics. In some cases, receiving the control message may include receiving a system information message that configures the UE to predict the one or more predicted signal characteristics.

In some cases, the control message may configure the UE to predict the one or more predicted signal characteristics based on a quantity of pairs of radio frequency spectrums including at least a first pair of the first radio frequency spectrum and the second radio frequency spectrum. In some cases, the control message may indicate an accuracy requirement that is associated with the first radio frequency spectrum and the second radio frequency spectrum.

In some examples, at 615, the UE 115-b may transmit, to the network entity 105-b, a request. For example, the UE 115-b may transmit a request for an increased quantity of reference signals via the first set of one or more beams to predict the one or more predicted signal characteristics. In some cases, the request for the increased quantity of reference signals may identify a CSI report setting associated with the first set of one or more beams.

At 620, the UE 115-b may monitor for one or more reference signals via the first set of one or more beams in the first radio frequency spectrum to obtain one or more measured signal characteristics. At 625, the network entity 105-b may transmit reference signals. For example, the network entity 105-b may transmit one or more reference signals via the first set of one or more beams in the first radio frequency spectrum. In some examples, the reference signals may be, for example, CSI-RS or SSBs.

At 630, the UE 115-b may predict signal characteristics. For example, the UE 115-b may predict, based on the one or more measured signal characteristics associated with the first radio frequency spectrum, the one or more predicted signal characteristics for the second set of one or more beams associated with the second radio frequency spectrum. For example, the UE 115-b may input the measured signal characteristics associated with the first radio frequency spectrum into a machine learning model, and the machine learning model may output prediction information (e.g., predicted signal characteristics) for the second set of one or more beams associated with the second radio frequency spectrum.

The UE 115-b may compare the predicted signal characteristics to an accuracy requirement or an accuracy threshold. In some cases, the accuracy requirement may be based on the one or more reference signal characteristics, a numerical quantity of the second set of one or more beams, a beam width associated with the second set of one or more beams, a beam type associated with the second set of one or more beams, a periodicity of the second set of one or more beams, or a combination thereof.

The UE 115-b may determine whether the predicted signal characteristics are within a threshold difference from one or more reference signal characteristics. In some cases, the one or more predicted signal characteristics may satisfy the accuracy requirement based on the one or more predicted signal characteristics being within a threshold difference from the one or more measured signal characteristics. For example, the one or more reference signal characteristics may correspond to the one or more measured signal characteristics, where the UE 115-b may use UE-measured signal characteristics (e.g., UE-measured SINR values or RSRP values) to determine whether the predicted signal characteristics satisfy an accuracy requirement.

In some cases, the one or more predicted signal characteristics may satisfy the accuracy requirement based on the one or more predicted signal characteristics being within a threshold difference from one or more ideal signal characteristics. For example, the one or more reference signal characteristics may correspond to the one or more ideal signal characteristics, where the UE 115-b may use ideal or generic signal characteristics to determine whether the predicted signal characteristics satisfy an accuracy requirement.

In some cases, the one or more predicted signal characteristics may satisfy the accuracy requirement based on time-frequency resources associated with the one or more predicted signal characteristics corresponding to time-frequency resources associated with each of the one or more reference signal characteristics. For example, top-K beam accuracy may be based on a probability of the UE-predicted top-K resources being the reference top-K resources.

In some cases, the one or more predicted signal characteristics may satisfy the accuracy requirement based on a time-frequency resource associated with highest predicted signal characteristic of the one or more predicted signal characteristics corresponding to a time-frequency resource associated with any of the one or more reference signal characteristics. For example, top-K beam accuracy may be based on a probability of the UE-predicted top-1 resource being within the reference top-K resources.

In some cases, the one or more predicted signal characteristics may satisfy the accuracy requirement based on a time-frequency resource associated with a highest reference signal characteristic of the one or more reference signal characteristics corresponding to a time-frequency resource associated with any of the one or more predicted signal characteristics. For example, top-K beam accuracy may be based on a probability of the top-1 reference resource being within the reference top-K predicted resources.

At 635, the UE 115-b may transmit, to the network entity 105-b, an indication. For example, the UE 115-b may transmit an indication of the one or more predicted signal characteristics based on the accuracy requirement that is associated with the first radio frequency spectrum, the second radio frequency spectrum, and one or more reference signal characteristics. In some examples, the UE 115-b may transmit the indication of the one or more predicted signal characteristics based on satisfying the accuracy requirement.

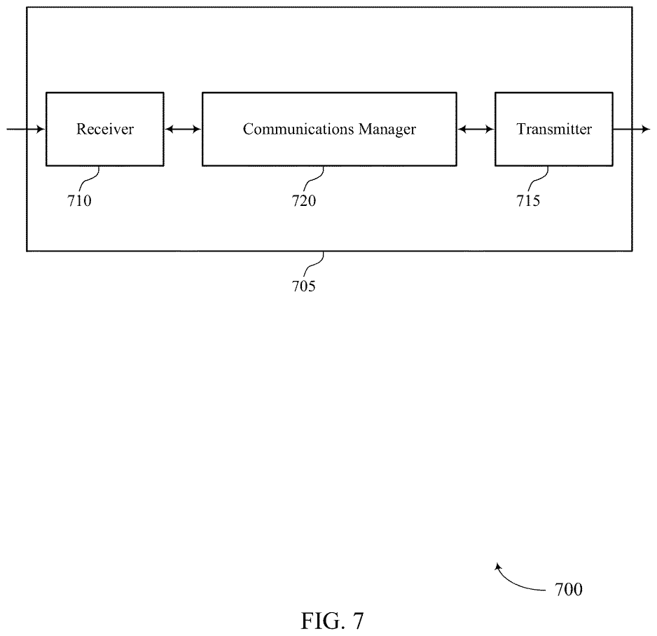

FIG. 7 shows a block diagram 700 of a device 705 that supports accuracy and capabilities for cross frequency-range beam prediction in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to accuracy and capabilities for cross frequency-range beam prediction). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to accuracy and capabilities for cross frequency-range beam prediction). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of accuracy and capabilities for cross frequency-range beam prediction as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software) executed by a processor. If implemented in code executed by a processor, the functions of the communications manager 720, the receiver 710, the transmitter 715, or various combinations or components thereof may be performed by a general-purpose processor, a DSP, a CPU, a graphics processing unit (GPU), an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. For example, the communications manager 720 is capable of, configured to, or operable to support a means for monitoring for one or more reference signals via a first set of one or more beams in a first radio frequency spectrum to obtain one or more measured signal characteristics. The communications manager 720 is capable of, configured to, or operable to support a means for predicting, based on the one or more measured signal characteristics associated with the first radio frequency spectrum, one or more predicted signal characteristics for a second set of one or more beams associated with a second radio frequency spectrum. The communications manager 720 is capable of, configured to, or operable to support a means for transmitting an indication of the one or more predicted signal characteristics based on an accuracy requirement that is associated with the first radio frequency spectrum, the second radio frequency spectrum, and one or more reference signal characteristics.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing and more efficient utilization of communication resources).

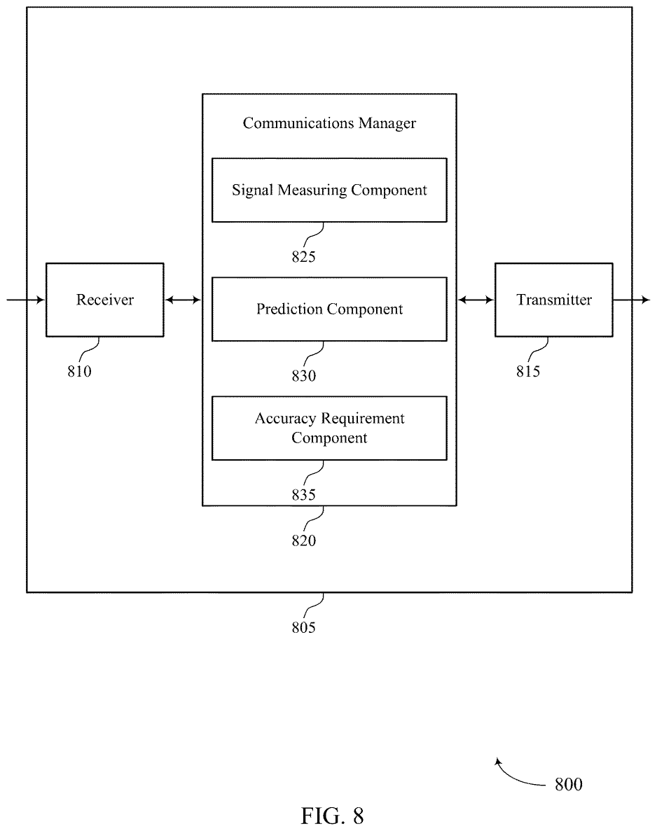

FIG. 8 shows a block diagram 800 of a device 805 that supports accuracy and capabilities for cross frequency-range beam prediction in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to accuracy and capabilities for cross frequency-range beam prediction). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to accuracy and capabilities for cross frequency-range beam prediction). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of accuracy and capabilities for cross frequency-range beam prediction as described herein. For example, the communications manager 820 may include a signal measuring component 825, a prediction component 830, an accuracy requirement component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. The signal measuring component 825 is capable of, configured to, or operable to support a means for monitoring for one or more reference signals via a first set of one or more beams in a first radio frequency spectrum to obtain one or more measured signal characteristics. The prediction component 830 is capable of, configured to, or operable to support a means for predicting, based on the one or more measured signal characteristics associated with the first radio frequency spectrum, one or more predicted signal characteristics for a second set of one or more beams associated with a second radio frequency spectrum. The accuracy requirement component 835 is capable of, configured to, or operable to support a means for transmitting an indication of the one or more predicted signal characteristics based on an accuracy requirement that is associated with the first radio frequency spectrum, the second radio frequency spectrum, and one or more reference signal characteristics.

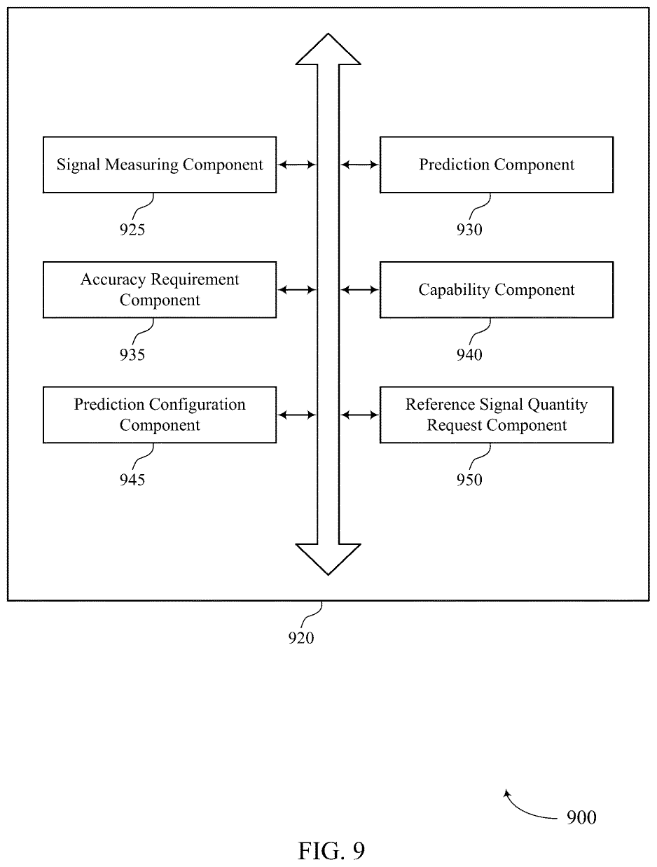

FIG. 9 shows a block diagram 900 of a communications manager 920 that supports accuracy and capabilities for cross frequency-range beam prediction in accordance with one or more aspects of the present disclosure. The communications manager 920 may be an example of aspects of a communications manager 720, a communications manager 820, or both, as described herein. The communications manager 920, or various components thereof, may be an example of means for performing various aspects of accuracy and capabilities for cross frequency-range beam prediction as described herein. For example, the communications manager 920 may include a signal measuring component 925, a prediction component 930, an accuracy requirement component 935, a capability component 940, a prediction configuration component 945, a reference signal quantity request component 950, or any combination thereof. Each of these components may communicate, directly or indirectly, with one another (e.g., via one or more buses).

The communications manager 920 may support wireless communication at a UE in accordance with examples as disclosed herein. The signal measuring component 925 is capable of, configured to, or operable to support a means for monitoring for one or more reference signals via a first set of one or more beams in a first radio frequency spectrum to obtain one or more measured signal characteristics. The prediction component 930 is capable of, configured to, or operable to support a means for predicting, based on the one or more measured signal characteristics associated with the first radio frequency spectrum, one or more predicted signal characteristics for a second set of one or more beams associated with a second radio frequency spectrum. The accuracy requirement component 935 is capable of, configured to, or operable to support a means for transmitting an indication of the one or more predicted signal characteristics based on an accuracy requirement that is associated with the first radio frequency spectrum, the second radio frequency spectrum, and one or more reference signal characteristics.

In some examples, the capability component 940 is capable of, configured to, or operable to support a means for transmitting a control message indicating a capability of the UE to predict the one or more predicted signal characteristics associated with the first radio frequency spectrum and the second radio frequency spectrum.

In some examples, the control message indicates the capability of the UE to predict the one or more predicted signal characteristics based on beams of the second set of one or more beams having a narrower beam width than beams of the first set of one or more beams, the beams of the second set of one or more beams being more frequently transmitted than the beams of the first set of one or more beams, a time duration between predicting the one or more predicted signal characteristics and a time associated with the one or more predicted signal characteristics, or predicted signal characteristics being greater than measured signal characteristics, or any combination thereof.

In some examples, the control message indicates the capability of the UE to predict the one or more predicted signal characteristics based on a quantity of beams in the first set of one or more beams or the second set of one or more beams, a beam width of the beams in the first set of one or more beams or in the second set of one or more beams, a frequency of the beams in the first set of one or more beams or the second set of one or more beams, or any combination thereof.

In some examples, the control message indicates the capability of the UE to predict the one or more predicted signal characteristics based on a set of multiple pairs of radio frequency spectrums including at least a first pair of the first radio frequency spectrum and the second radio frequency spectrum.

In some examples, the capability component 940 is capable of, configured to, or operable to support a means for transmitting an indication of an updated capability of the UE to predict the one or more predicted signal characteristics.

In some examples, the updated capability of the UE is based on a change to channel conditions, a change to resource availability at the UE, a change to the accuracy requirement, or any combination thereof.

In some examples, the prediction configuration component 945 is capable of, configured to, or operable to support a means for receiving a control message that configures the UE to predict the one or more predicted signal characteristics, where predicting the one or more predicted signal characteristics is based on the control message.

In some examples, the control message identifies the first radio frequency spectrum and the second radio frequency spectrum for predicting the one or more predicted signal characteristics.

In some examples, to support receiving the control message, prediction configuration component 945 is capable of, configured to, or operable to support a means for receiving a system information message that configures the UE to predict the one or more predicted signal characteristics.

In some examples, the control message configures the UE to predict the one or more predicted signal characteristics based on a set of multiple pairs of radio frequency spectrums including at least a first pair of the first radio frequency spectrum and the second radio frequency spectrum.

In some examples, the control message indicates the accuracy requirement that is associated with the first radio frequency spectrum and the second radio frequency spectrum.

In some examples, the reference signal quantity request component 950 is capable of, configured to, or operable to support a means for transmitting a request for an increased quantity of reference signals via the first set of one or more beams to predict the one or more predicted signal characteristics.

In some examples, the request for the increased quantity of reference signals identifies a CSI report setting associated with the first set of one or more beams.

In some examples, the one or more predicted signal characteristics satisfy the accuracy requirement based on the one or more predicted signal characteristics being within a threshold difference from the one or more measured signal characteristics. In some examples, the one or more reference signal characteristics correspond to the one or more measured signal characteristics.

In some examples, the one or more predicted signal characteristics satisfy the accuracy requirement based on the one or more predicted signal characteristics being within a threshold difference from one or more ideal signal characteristics. In some examples, the one or more reference signal characteristics correspond to the one or more ideal signal characteristics.

In some examples, the one or more predicted signal characteristics satisfy the accuracy requirement based on time-frequency resources associated with the one or more predicted signal characteristics corresponding to time-frequency resources associated with each of the one or more reference signal characteristics.

In some examples, the one or more predicted signal characteristics satisfy the accuracy requirement based on a time-frequency resource associated with highest predicted signal characteristic of the one or more predicted signal characteristics corresponding to a time-frequency resource associated with any of the one or more reference signal characteristics.

In some examples, the one or more predicted signal characteristics satisfy the accuracy requirement based on a time-frequency resource associated with a highest reference signal characteristic of the one or more reference signal characteristics corresponding to a time-frequency resource associated with any of the one or more predicted signal characteristics.

In some examples, the accuracy requirement is a first accuracy requirement of a set of multiple accuracy requirements, each respective accuracy requirement of the set of multiple accuracy requirements being based on a first respective radio frequency spectrum associated with measurements and a second respective radio frequency spectrum associated with signal characteristic predictions.

In some examples, the accuracy requirement is based on the one or more reference signal characteristics, a numerical quantity of the second set of one or more beams, a beam width associated with the second set of one or more beams, a beam type associated with the second set of one or more beams, a periodicity of the second set of one or more beams, or a combination thereof.

In some examples, the first radio frequency spectrum corresponds a first frequency range, and the second radio frequency spectrum corresponds to a second frequency range.

In some examples, the first radio frequency spectrum corresponds a first sub-portion of a first frequency range, and the second radio frequency spectrum corresponds to a second sub-portion of a second frequency range.

In some examples, the first radio frequency spectrum corresponds a first radio frequency spectrum band, and the second radio frequency spectrum corresponds to a second radio frequency spectrum band.

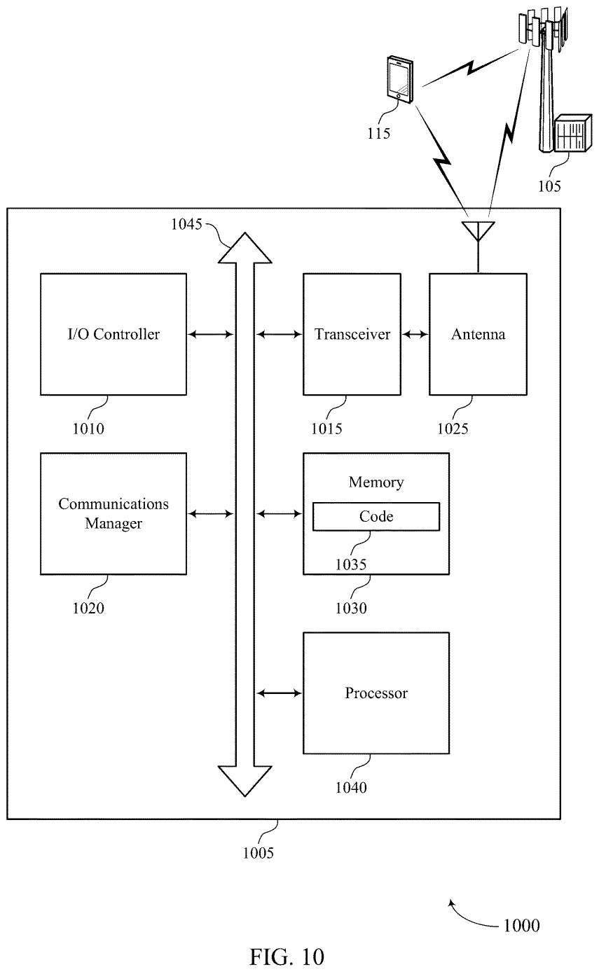

FIG. 10 shows a diagram of a system 1000 including a device 1005 that supports accuracy and capabilities for cross frequency-range beam prediction in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting accuracy and capabilities for cross frequency-range beam prediction). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE in accordance with examples as disclosed herein. For example, the communications manager 1020 is capable of, configured to, or operable to support a means for monitoring for one or more reference signals via a first set of one or more beams in a first radio frequency spectrum to obtain one or more measured signal characteristics. The communications manager 1020 is capable of, configured to, or operable to support a means for predicting, based on the one or more measured signal characteristics associated with the first radio frequency spectrum, one or more predicted signal characteristics for a second set of one or more beams associated with a second radio frequency spectrum. The communications manager 1020 is capable of, configured to, or operable to support a means for transmitting an indication of the one or more predicted signal characteristics based on an accuracy requirement that is associated with the first radio frequency spectrum, the second radio frequency spectrum, and one or more reference signal characteristics.

By including or configuring the communications manager 1020 in accordance with examples as described herein, the device 1005 may support techniques for improved communication reliability, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of accuracy and capabilities for cross frequency-range beam prediction as described herein, or the processor 1040 and the memory 1030 may be otherwise configured to perform or support such operations.

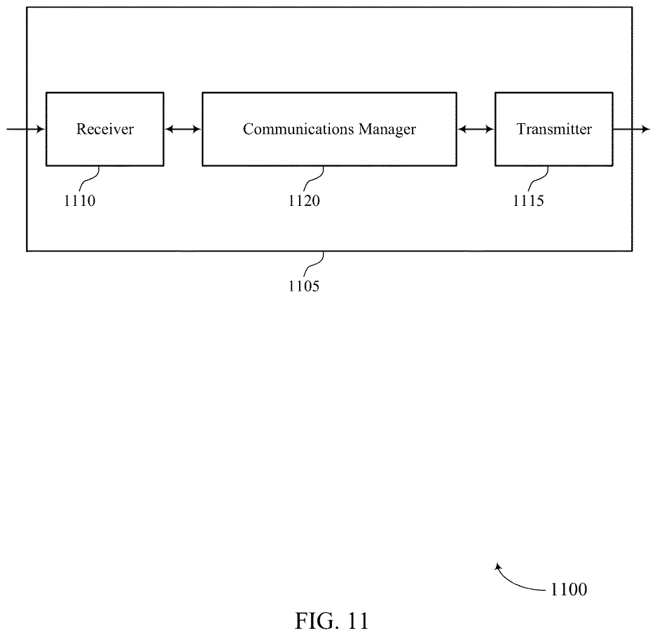

FIG. 11 shows a block diagram 1100 of a device 1105 that supports accuracy and capabilities for cross frequency-range beam prediction in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of accuracy and capabilities for cross frequency-range beam prediction as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software) executed by a processor. If implemented in code executed by a processor, the functions of the communications manager 1120, the receiver 1110, the transmitter 1115, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. For example, the communications manager 1120 is capable of, configured to, or operable to support a means for receiving a control message indicating a capability of a UE to predict one or more predicted signal characteristics of a second set of one or more beams in a second radio frequency spectrum based on one or more measured signal characteristics of a first set of one or more beams in a first radio frequency spectrum. The communications manager 1120 is capable of, configured to, or operable to support a means for transmitting one or more reference signals via the first set of one or more beams in the first radio frequency spectrum. The communications manager 1120 is capable of, configured to, or operable to support a means for receiving an indication of the one or more predicted signal characteristics for the second set of one or more beams in the second radio frequency spectrum based on an accuracy requirement that is associated with the first radio frequency spectrum, the second radio frequency spectrum, and one or more reference signal characteristics.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced processing and more efficient utilization of communication resources.

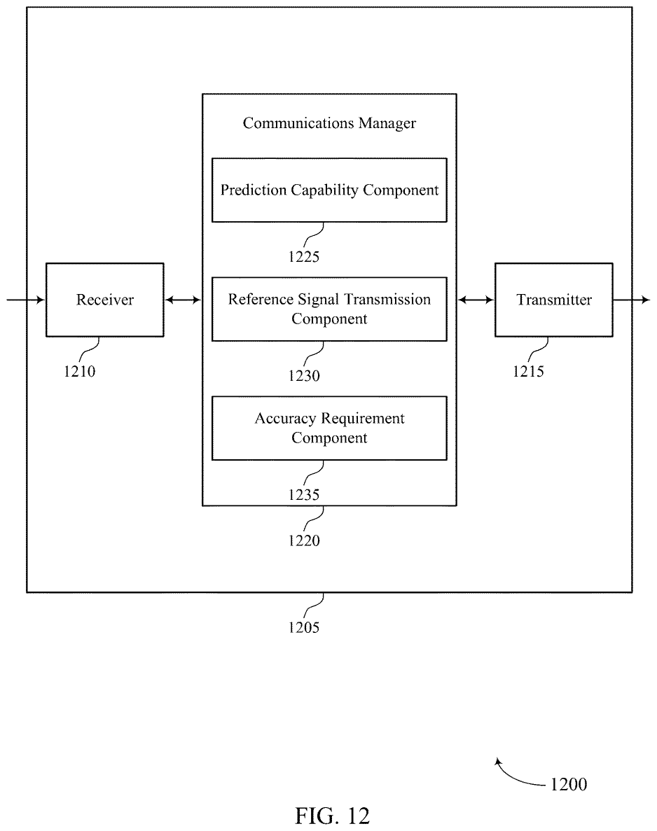

FIG. 12 shows a block diagram 1200 of a device 1205 that supports accuracy and capabilities for cross frequency-range beam prediction in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of accuracy and capabilities for cross frequency-range beam prediction as described herein. For example, the communications manager 1220 may include a prediction capability component 1225, a reference signal transmission component 1230, an accuracy requirement component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. The prediction capability component 1225 is capable of, configured to, or operable to support a means for receiving a control message indicating a capability of a UE to predict one or more predicted signal characteristics of a second set of one or more beams in a second radio frequency spectrum based on one or more measured signal characteristics of a first set of one or more beams in a first radio frequency spectrum. The reference signal transmission component 1230 is capable of, configured to, or operable to support a means for transmitting one or more reference signals via the first set of one or more beams in the first radio frequency spectrum. The accuracy requirement component 1235 is capable of, configured to, or operable to support a means for receiving an indication of the one or more predicted signal characteristics for the second set of one or more beams in the second radio frequency spectrum based on an accuracy requirement that is associated with the first radio frequency spectrum, the second radio frequency spectrum, and one or more reference signal characteristics.

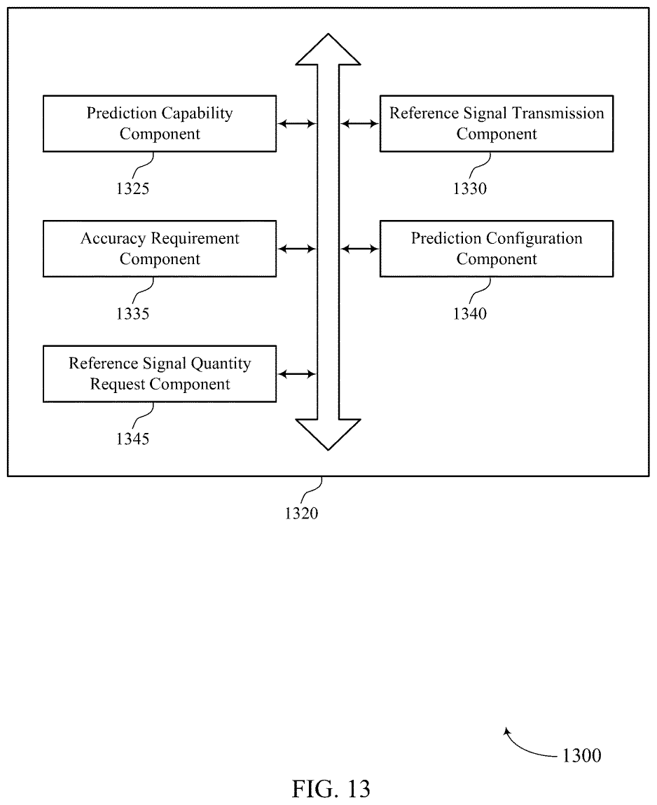

FIG. 13 shows a block diagram 1300 of a communications manager 1320 that supports accuracy and capabilities for cross frequency-range beam prediction in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of accuracy and capabilities for cross frequency-range beam prediction as described herein. For example, the communications manager 1320 may include a prediction capability component 1325, a reference signal transmission component 1330, an accuracy requirement component 1335, a prediction configuration component 1340, a reference signal quantity request component 1345, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The prediction capability component 1325 is capable of, configured to, or operable to support a means for receiving a control message indicating a capability of a UE to predict one or more predicted signal characteristics of a second set of one or more beams in a second radio frequency spectrum based on one or more measured signal characteristics of a first set of one or more beams in a first radio frequency spectrum. The reference signal transmission component 1330 is capable of, configured to, or operable to support a means for transmitting one or more reference signals via the first set of one or more beams in the first radio frequency spectrum. The accuracy requirement component 1335 is capable of, configured to, or operable to support a means for receiving an indication of the one or more predicted signal characteristics for the second set of one or more beams in the second radio frequency spectrum based on an accuracy requirement that is associated with the first radio frequency spectrum, the second radio frequency spectrum, and one or more reference signal characteristics.

In some examples, the control message indicates the capability of the UE to predict the one or more predicted signal characteristics based on beams of the second set of one or more beams having a narrower beam width than beams of the first set of one or more beams, the beams of the second set of one or more beams being more frequently transmitted than the beams of the first set of one or more beams, a time duration between predicting the one or more predicted signal characteristics and a time associated with the one or more predicted signal characteristics, or predicted signal characteristics being greater than measured signal characteristics, or any combination thereof.

In some examples, the prediction configuration component 1340 is capable of, configured to, or operable to support a means for transmitting control signaling that configures the UE to predict the one or more predicted signal characteristics, where receiving the indication of the one or more predicted signal characteristics is based on the control message.

In some examples, the reference signal quantity request component 1345 is capable of, configured to, or operable to support a means for receiving a request for an increased quantity of reference signals via the first set of one or more beams for the UE to predict the one or more predicted signal characteristics.

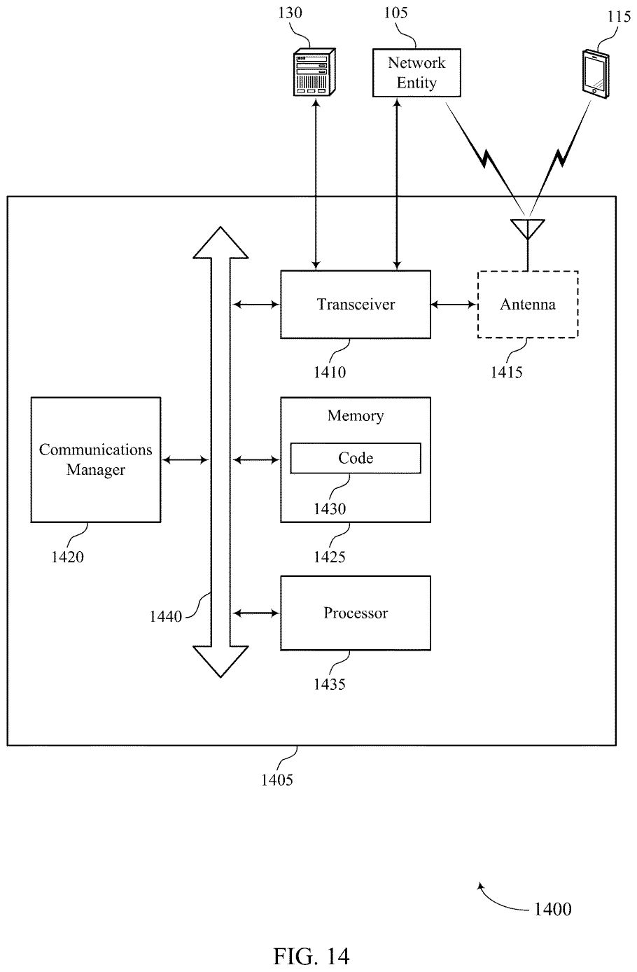

FIG. 14 shows a diagram of a system 1400 including a device 1405 that supports accuracy and capabilities for cross frequency-range beam prediction in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting accuracy and capabilities for cross frequency-range beam prediction). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity in accordance with examples as disclosed herein. For example, the communications manager 1420 is capable of, configured to, or operable to support a means for receiving a control message indicating a capability of a UE to predict one or more predicted signal characteristics of a second set of one or more beams in a second radio frequency spectrum based on one or more measured signal characteristics of a first set of one or more beams in a first radio frequency spectrum. The communications manager 1420 is capable of, configured to, or operable to support a means for transmitting one or more reference signals via the first set of one or more beams in the first radio frequency spectrum. The communications manager 1420 is capable of, configured to, or operable to support a means for receiving an indication of the one or more predicted signal characteristics for the second set of one or more beams in the second radio frequency spectrum based on an accuracy requirement that is associated with the first radio frequency spectrum, the second radio frequency spectrum, and one or more reference signal characteristics.

By including or configuring the communications manager 1420 in accordance with examples as described herein, the device 1405 may support techniques for improved communication reliability and improved coordination between devices.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of accuracy and capabilities for cross frequency-range beam prediction as described herein, or the processor 1435 and the memory 1425 may be otherwise configured to perform or support such operations.

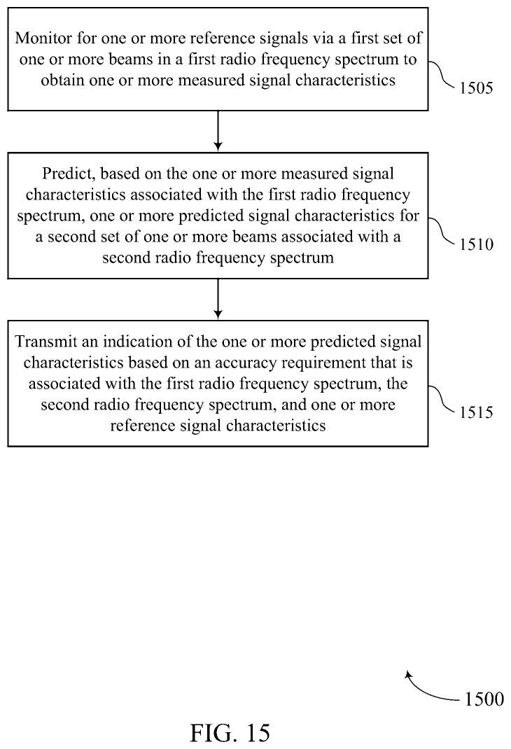

FIG. 15 shows a flowchart illustrating a method 1500 that supports accuracy and capabilities for cross frequency-range beam prediction in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1505, the method may include monitoring for one or more reference signals via a first set of one or more beams in a first radio frequency spectrum to obtain one or more measured signal characteristics. The operations of 1505 may be performed in accordance with examples as disclosed herein. In some examples, aspects of the operations of 1505 may be performed by a signal measuring component 925 as described with reference to FIG. 9.

At 1510, the method may include predicting, based on the one or more measured signal characteristics associated with the first radio frequency spectrum, one or more predicted signal characteristics for a second set of one or more beams associated with a second radio frequency spectrum. The operations of 1510 may be performed in accordance with examples as disclosed herein. In some examples, aspects of the operations of 1510 may be performed by a prediction component 930 as described with reference to FIG. 9.

At 1515, the method may include transmitting an indication of the one or more predicted signal characteristics based on an accuracy requirement that is associated with the first radio frequency spectrum, the second radio frequency spectrum, and one or more reference signal characteristics. The operations of 1515 may be performed in accordance with examples as disclosed herein. In some examples, aspects of the operations of 1515 may be performed by an accuracy requirement component 935 as described with reference to FIG. 9.

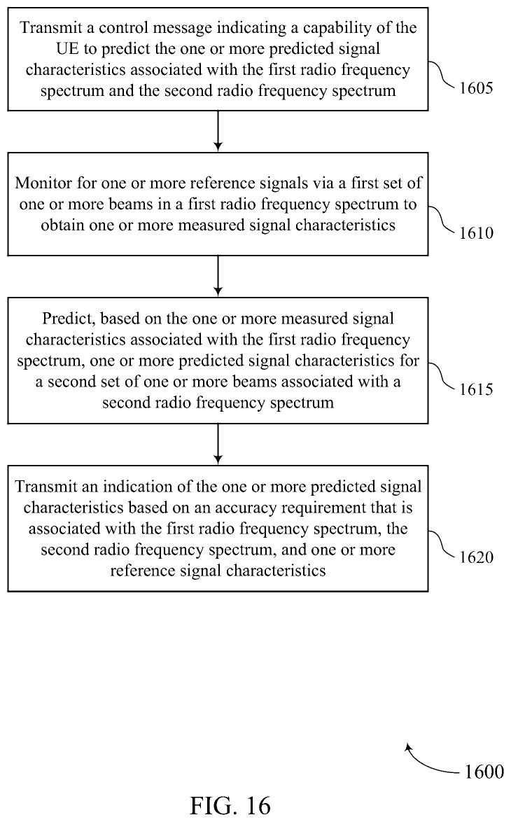

FIG. 16 shows a flowchart illustrating a method 1600 that supports accuracy and capabilities for cross frequency-range beam prediction in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the wireless UE to perform the described functions. Additionally, or alternatively, the wireless UE may perform aspects of the described functions using special-purpose hardware.

At 1605, the method may include transmitting a control message indicating a capability of the UE to predict the one or more predicted signal characteristics associated with the first radio frequency spectrum and the second radio frequency spectrum. The operations of 1605 may be performed in accordance with examples as disclosed herein. In some examples, aspects of the operations of 1605 may be performed by a capability component 940 as described with reference to FIG. 9.

At 1610, the method may include monitoring for one or more reference signals via a first set of one or more beams in a first radio frequency spectrum to obtain one or more measured signal characteristics. The operations of 1610 may be performed in accordance with examples as disclosed herein. In some examples, aspects of the operations of 1610 may be performed by a signal measuring component 925 as described with reference to FIG. 9.

At 1615, the method may include predicting, based on the one or more measured signal characteristics associated with the first radio frequency spectrum, one or more predicted signal characteristics for a second set of one or more beams associated with a second radio frequency spectrum. The operations of 1615 may be performed in accordance with examples as disclosed herein. In some examples, aspects of the operations of 1615 may be performed by a prediction component 930 as described with reference to FIG. 9.

At 1620, the method may include transmitting an indication of the one or more predicted signal characteristics based on an accuracy requirement that is associated with the first radio frequency spectrum, the second radio frequency spectrum, and one or more reference signal characteristics. The operations of 1620 may be performed in accordance with examples as disclosed herein. In some examples, aspects of the operations of 1620 may be performed by an accuracy requirement component 935 as described with reference to FIG. 9.

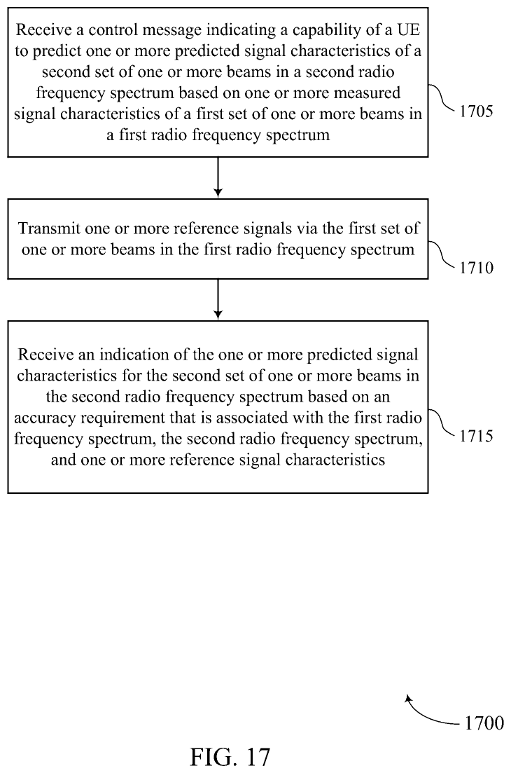

FIG. 17 shows a flowchart illustrating a method 1700 that supports accuracy and capabilities for cross frequency-range beam prediction in accordance with aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the wireless network entity to perform the described functions. Additionally, or alternatively, the wireless network entity may perform aspects of the described functions using special-purpose hardware.

At 1705, the method may include receiving a control message indicating a capability of a UE to predict one or more predicted signal characteristics of a second set of one or more beams in a second radio frequency spectrum based on one or more measured signal characteristics of a first set of one or more beams in a first radio frequency spectrum. The operations of 1705 may be performed in accordance with examples as disclosed herein. In some examples, aspects of the operations of 1705 may be performed by a prediction capability component 1325 as described with reference to FIG. 13.

At 1710, the method may include transmitting one or more reference signals via the first set of one or more beams in the first radio frequency spectrum. The operations of 1710 may be performed in accordance with examples as disclosed herein. In some examples, aspects of the operations of 1710 may be performed by a reference signal transmission component 1330 as described with reference to FIG. 13.

At 1715, the method may include receiving an indication of the one or more predicted signal characteristics for the second set of one or more beams in the second radio frequency spectrum based on an accuracy requirement that is associated with the first radio frequency spectrum, the second radio frequency spectrum, and one or more reference signal characteristics. The operations of 1715 may be performed in accordance with examples as disclosed herein. In some examples, aspects of the operations of 1715 may be performed by an accuracy requirement component 1335 as described with reference to FIG. 13.

The following provides an overview of aspects of the present disclosure:

Aspect 1: A method for wireless communication at a UE, comprising: monitoring for one or more reference signals via a first set of one or more beams in a first radio frequency spectrum to obtain one or more measured signal characteristics; predicting, based at least in part on the one or more measured signal characteristics associated with the first radio frequency spectrum, one or more predicted signal characteristics for a second set of one or more beams associated with a second radio frequency spectrum; and transmitting an indication of the one or more predicted signal characteristics based at least in part on an accuracy requirement that is associated with the first radio frequency spectrum, the second radio frequency spectrum, and one or more reference signal characteristics.

Aspect 2: The method of aspect 1, further comprising: transmitting a control message indicating a capability of the UE to predict the one or more predicted signal characteristics associated with the first radio frequency spectrum and the second radio frequency spectrum.

Aspect 3: The method of aspect 2, wherein the control message indicates the capability of the UE to predict the one or more predicted signal characteristics based at least in part on beams of the second set of one or more beams having a narrower beam width than beams of the first set of one or more beams, the beams of the second set of one or more beams being more frequently transmitted than the beams of the first set of one or more beams, a time duration between predicting the one or more predicted signal characteristics and a time associated with the one or more predicted signal characteristics, or predicted signal characteristics being greater than measured signal characteristics, or any combination thereof.

Aspect 4: The method of any of aspects 2 through 3, wherein the control message indicates the capability of the UE to predict the one or more predicted signal characteristics based at least in part on a quantity of beams in the first set of one or more beams or the second set of one or more beams, a beam width of the beams in the first set of one or more beams or in the second set of one or more beams, a frequency of the beams in the first set of one or more beams or the second set of one or more beams, or any combination thereof.

Aspect 5: The method of any of aspects 2 through 4, wherein the control message indicates the capability of the UE to predict the one or more predicted signal characteristics based at least in part on a plurality of pairs of radio frequency spectrums including at least a first pair of the first radio frequency spectrum and the second radio frequency spectrum.

Aspect 6: The method of any of aspects 2 through 5, further comprising: transmitting an indication of an updated capability of the UE to predict the one or more predicted signal characteristics.

Aspect 7: The method of aspect 6, wherein the updated capability of the UE is based at least in part on a change to channel conditions, a change to resource availability at the UE, a change to the accuracy requirement, or any combination thereof.

Aspect 8: The method of any of aspects 1 through 7, further comprising: receiving a control message that configures the UE to predict the one or more predicted signal characteristics, wherein predicting the one or more predicted signal characteristics is based at least in part on the control message.

Aspect 9: The method of aspect 8, wherein the control message identifies the first radio frequency spectrum and the second radio frequency spectrum for predicting the one or more predicted signal characteristics.

Aspect 10: The method of any of aspects 8 through 9, wherein receiving the control message comprises: receiving a system information message that configures the UE to predict the one or more predicted signal characteristics.

Aspect 11: The method of any of aspects 8 through 10, wherein the control message configures the UE to predict the one or more predicted signal characteristics based at least in part on a plurality of pairs of radio frequency spectrums including at least a first pair of the first radio frequency spectrum and the second radio frequency spectrum.

Aspect 12: The method of any of aspects 8 through 11, wherein the control message indicates the accuracy requirement that is associated with the first radio frequency spectrum and the second radio frequency spectrum.

Aspect 13: The method of any of aspects 1 through 12, further comprising: transmitting a request for an increased quantity of reference signals via the first set of one or more beams to predict the one or more predicted signal characteristics.

Aspect 14: The method of aspect 13, wherein the request for the increased quantity of reference signals identifies a CSI report setting associated with the first set of one or more beams.

Aspect 15: The method of any of aspects 1 through 14, wherein the one or more predicted signal characteristics satisfy the accuracy requirement based at least in part on the one or more predicted signal characteristics being within a threshold difference from the one or more measured signal characteristics, the one or more reference signal characteristics correspond to the one or more measured signal characteristics.

Aspect 16: The method of any of aspects 1 through 15, wherein the one or more predicted signal characteristics satisfy the accuracy requirement based at least in part on the one or more predicted signal characteristics being within a threshold difference from one or more ideal signal characteristics, the one or more reference signal characteristics correspond to the one or more ideal signal characteristics.

Aspect 17: The method of any of aspects 1 through 16, wherein the one or more predicted signal characteristics satisfy the accuracy requirement based at least in part on time-frequency resources associated with the one or more predicted signal characteristics corresponding to time-frequency resources associated with each of the one or more reference signal characteristics.

Aspect 18: The method of any of aspects 1 through 17, wherein the one or more predicted signal characteristics satisfy the accuracy requirement based at least in part on a time-frequency resource associated with highest predicted signal characteristic of the one or more predicted signal characteristics corresponding to a time-frequency resource associated with any of the one or more reference signal characteristics.

Aspect 19: The method of any of aspects 1 through 18, wherein the one or more predicted signal characteristics satisfy the accuracy requirement based at least in part on a time-frequency resource associated with a highest reference signal characteristic of the one or more reference signal characteristics corresponding to a time-frequency resource associated with any of the one or more predicted signal characteristics.

Aspect 20: The method of any of aspects 1 through 19, wherein the accuracy requirement is a first accuracy requirement of a plurality of accuracy requirements, each respective accuracy requirement of the plurality of accuracy requirements being based at least in part on a first respective radio frequency spectrum associated with measurements and a second respective radio frequency spectrum associated with signal characteristic predictions.

Aspect 21: The method of any of aspects 1 through 20, wherein the accuracy requirement is based at least in part on the one or more reference signal characteristics, a numerical quantity of the second set of one or more beams, a beam width associated with the second set of one or more beams, a beam type associated with the second set of one or more beams, a periodicity of the second set of one or more beams, or a combination thereof.

Aspect 22: The method of any of aspects 1 through 21, wherein the first radio frequency spectrum corresponds a first frequency range, and the second radio frequency spectrum corresponds to a second frequency range.

Aspect 23: The method of any of aspects 1 through 22, wherein the first radio frequency spectrum corresponds a first sub-portion of a first frequency range, and the second radio frequency spectrum corresponds to a second sub-portion of a second frequency range.

Aspect 24: The method of any of aspects 1 through 23, wherein the first radio frequency spectrum corresponds a first radio frequency spectrum band, and the second radio frequency spectrum corresponds to a second radio frequency spectrum band.

Aspect 25: A method for wireless communication at a network entity, comprising: receiving a control message indicating a capability of a UE to predict one or more predicted signal characteristics of a second set of one or more beams in a second radio frequency spectrum based at least in part on one or more measured signal characteristics of a first set of one or more beams in a first radio frequency spectrum; transmitting one or more reference signals via the first set of one or more beams in the first radio frequency spectrum; and receiving an indication of the one or more predicted signal characteristics for the second set of one or more beams in the second radio frequency spectrum based at least in part on an accuracy requirement that is associated with the first radio frequency spectrum, the second radio frequency spectrum, and one or more reference signal characteristics.

Aspect 26: The method of aspect 25, wherein the control message indicates the capability of the UE to predict the one or more predicted signal characteristics based at least in part on beams of the second set of one or more beams having a narrower beam width than beams of the first set of one or more beams, the beams of the second set of one or more beams being more frequently transmitted than the beams of the first set of one or more beams, a time duration between predicting the one or more predicted signal characteristics and a time associated with the one or more predicted signal characteristics, or predicted signal characteristics being greater than measured signal characteristics, or any combination thereof.

Aspect 27: The method of any of aspects 25 through 26, further comprising: transmitting control signaling that configures the UE to predict the one or more predicted signal characteristics, wherein receiving the indication of the one or more predicted signal characteristics is based at least in part on the control message.

Aspect 28: The method of any of aspects 25 through 27, further comprising: receiving a request for an increased quantity of reference signals via the first set of one or more beams for the UE to predict the one or more predicted signal characteristics.

Aspect 29: An apparatus for wireless communication at a UE, comprising at least one processor; and memory coupled with the at least one processor, the memory storing instructions executable by the at least one processor to cause the UE to perform a method of any of aspects 1 through 24.

Aspect 30: An apparatus for wireless communication at a UE, comprising at least one means for performing a method of any of aspects 1 through 24.

Aspect 31: A non-transitory computer-readable medium storing code for wireless communication at a UE, the code comprising instructions executable by at least one processor to perform a method of any of aspects 1 through 24.

Aspect 32: An apparatus for wireless communication at a network entity, comprising at least one processor; and memory coupled with the at least one processor, the memory storing instructions executable by the at least one processor to cause the network entity to perform a method of any of aspects 25 through 28.

Aspect 33: An apparatus for wireless communication at a network entity, comprising at least one means for performing a method of any of aspects 25 through 28.

Aspect 34: A non-transitory computer-readable medium storing code for wireless communication at a network entity, the code comprising instructions executable by at least one processor to perform a method of any of aspects 25 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
at least one processor; and
memory coupled with the at least one processor, the memory storing instructions executable by the at least one processor to cause the UE to:
monitor for one or more reference signals via a first set of one or more beams in a first radio frequency spectrum to obtain one or more measured signal characteristics;
predict, based at least in part on the one or more measured signal characteristics associated with the first radio frequency spectrum, one or more predicted signal characteristics for a second set of one or more beams associated with a second radio frequency spectrum; and
transmit an indication of the one or more predicted signal characteristics based at least in part on an accuracy requirement that is associated with the first radio frequency spectrum, the second radio frequency spectrum, and one or more reference signal characteristics.

2. The apparatus of claim 1, wherein the instructions are further executable by the at least one processor to cause the UE to:
transmit a control message indicating a capability of the UE to predict the one or more predicted signal characteristics associated with the first radio frequency spectrum and the second radio frequency spectrum.

3. The apparatus of claim 2, wherein the control message indicates the capability of the UE to predict the one or more predicted signal characteristics based at least in part on beams of the second set of one or more beams having a narrower beam width than beams of the first set of one or more beams, the beams of the second set of one or more beams being more frequently transmitted than the beams of the first set of one or more beams, a time duration between predicting the one or more predicted signal characteristics and a time associated with the one or more predicted signal characteristics, or predicted signal characteristics being greater than measured signal characteristics, or any combination thereof.

4. The apparatus of claim 2, wherein the control message indicates the capability of the UE to predict the one or more predicted signal characteristics based at least in part on a quantity of beams in the first set of one or more beams or the second set of one or more beams, a beam width of the beams in the first set of one or more beams or in the second set of one or more beams, a frequency of the beams in the first set of one or more beams or the second set of one or more beams, or any combination thereof.

5. The apparatus of claim 2, wherein the control message indicates the capability of the UE to predict the one or more predicted signal characteristics based at least in part on a plurality of pairs of radio frequency spectrums including at least a first pair of the first radio frequency spectrum and the second radio frequency spectrum.

6. The apparatus of claim 2, wherein the instructions are further executable by the at least one processor to cause the UE to:
transmit an indication of an updated capability of the UE to predict the one or more predicted signal characteristics.

7. The apparatus of claim 6, wherein the updated capability of the UE is based at least in part on a change to channel conditions, a change to resource availability at the UE, a change to the accuracy requirement, or any combination thereof.

8. The apparatus of claim 1, wherein the instructions are further executable by the at least one processor to cause the UE to:
receive a control message that configures the UE to predict the one or more predicted signal characteristics, wherein predicting the one or more predicted signal characteristics is based at least in part on the control message.

9. The apparatus of claim 8, wherein the control message identifies the first radio frequency spectrum and the second radio frequency spectrum for predicting the one or more predicted signal characteristics.

10. The apparatus of claim 8, wherein the instructions to receive the control message are executable by the at least one processor to cause the UE to:
receive a system information message that configures the UE to predict the one or more predicted signal characteristics.

11. The apparatus of claim 8, wherein the control message configures the UE to predict the one or more predicted signal characteristics based at least in part on a plurality of pairs of radio frequency spectrums including at least a first pair of the first radio frequency spectrum and the second radio frequency spectrum.

12. The apparatus of claim 8, wherein the control message indicates the accuracy requirement that is associated with the first radio frequency spectrum and the second radio frequency spectrum.

13. The apparatus of claim 1, wherein the instructions are further executable by the at least one processor to cause the UE to:
transmit a request for an increased quantity of reference signals via the first set of one or more beams to predict the one or more predicted signal characteristics.

14. The apparatus of claim 13, wherein the request for the increased quantity of reference signals identifies a channel state information (CSI) report setting associated with the first set of one or more beams.

15. The apparatus of claim 1, wherein:
the one or more predicted signal characteristics satisfy the accuracy requirement based at least in part on the one or more predicted signal characteristics being within a threshold difference from the one or more measured signal characteristics, and the one or more reference signal characteristics correspond to the one or more measured signal characteristics.

16-24. (canceled)

25. An apparatus for wireless communication at a network entity, comprising:
at least one processor; and
memory coupled with the at least one processor, the memory storing instructions executable by the at least one processor to cause the network entity to:
receive a control message indicating a capability of a user equipment (UE) to predict one or more predicted signal characteristics of a second set of one or more beams in a second radio frequency spectrum based at least in part on one or more measured signal characteristics of a first set of one or more beams in a first radio frequency spectrum;
transmit one or more reference signals via the first set of one or more beams in the first radio frequency spectrum; and
receive an indication of the one or more predicted signal characteristics for the second set of one or more beams in the second radio frequency spectrum based at least in part on an accuracy requirement that is associated with the first radio frequency spectrum, the second radio frequency spectrum, and one or more reference signal characteristics.

26. The apparatus of claim 25, wherein the control message indicates the capability of the UE to predict the one or more predicted signal characteristics based at least in part on beams of the second set of one or more beams having a narrower beam width than beams of the first set of one or more beams, the beams of the second set of one or more beams being more frequently transmitted than the beams of the first set of one or more beams, a time duration between predicting the one or more predicted signal characteristics and a time associated with the one or more predicted signal characteristics, or predicted signal characteristics being greater than measured signal characteristics, or any combination thereof.

27. The apparatus of claim 25, wherein the instructions are further executable by the at least one processor to cause the network entity to:
transmit control signaling that configures the UE to predict the one or more predicted signal characteristics, wherein receiving the indication of the one or more predicted signal characteristics is based at least in part on the control message.

28. The apparatus of claim 25, wherein the instructions are further executable by the at least one processor to cause the network entity to:
receive a request for an increased quantity of reference signals via the first set of one or more beams for the UE to predict the one or more predicted signal characteristics.

29. A method for wireless communication at a user equipment (UE), comprising:
monitoring for one or more reference signals via a first set of one or more beams in a first radio frequency spectrum to obtain one or more measured signal characteristics;
predicting, based at least in part on the one or more measured signal characteristics associated with the first radio frequency spectrum, one or more predicted signal characteristics for a second set of one or more beams associated with a second radio frequency spectrum; and
transmitting an indication of the one or more predicted signal characteristics based at least in part on an accuracy requirement that is associated with the first radio frequency spectrum, the second radio frequency spectrum, and one or more reference signal characteristics.

30. (canceled)
